(19) United States
(12) Patent Application Publication
(10) Pub. No.: US 2017/0279109 A1
(43) Pub. Date: Sep. 28, 2017

(54) LITHIUM METAL OXIDE COMPOSITES, AND METHODS FOR PREPARING AND USING THEREOF

(71) Applicant: NIVO SYSTEMS, INC., Culver City, CA (US)

(72) Inventor: Bo WANG, Beijing (CN)

(21) Appl. No.: 15/506,177

(22) PCT Filed: Aug. 27, 2015
(86) PCT No.: PCT/CN2015/088201

§ 371 Date: Feb. 23, 2017

Related U.S. Application Data
(60) Provisional application No. 62/073,831, filed on Oct. 31, 2014.
(60) Provisional application No. 62/042,637, filed on Aug. 27, 2014.

(51) Int. Cl. H01M 4/04; H01M 4/66; H01M 4/525; H01M 4/1391; H01M 4/36; H01M 4/505

(52) U.S. Cl. CPC H01M 4/0471; H01M 4/366; H01M 4/505; H01M 4/525; H01M 4/1391; H01M 4/663

(57) ABSTRACT

Provided herein are lithium metal oxide composites made up of lithium metal oxide coated with a metal oxide shell. The metal oxide shell may include a plurality of metal oxide particles dispersed in a porous carbon matrix. Such composites may be suitable for use as electrode materials, or more specifically for use in batteries. Provided herein are also methods for producing such composites involving the mechanochemical processing of metal-organic frameworks with lithium metal oxide to produce lithium metal oxide coated with a metal-organic framework shell, which is then pyrolyzed.

### CROSS-REFERENCE TO RELATED APPLICATIONS

This application claims priority to U.S. Provisional Patent Application No. 62/042,637, filed Aug. 27, 2014, and U.S. Provisional Patent Application No. 62/073,831, filed Oct. 31, 2014, which are incorporated herein by reference in their entireties.

### FIELD

The present disclosure relates generally to lithium metal oxide composites suitable for use in electrodes of lithium ion batteries, and more specifically to composites made up of lithium metal oxides having a metal oxide coating prepared from metal-organic frameworks.

### BACKGROUND

Lithium metal oxides are widely used as cathode materials in commercial lithium-ion batteries due to their high energy densities and cyclabilities. For example, when commercial lithium-ion batteries use LiCoO₂ as the cathode material, the theoretical capacity of LiCoO₂ is typically not utilized. To access more than 50% of the theoretical capacity of LiCoO₂, the cathode typically needs to be charged to above 4.2 V. Cycling above 4.2 V, however, may lead to a dramatic deterioration in capacity retention, which may be related to structural changes in the unit-cell volume.

Further, the electrolyte often used in such lithium-ion batteries, such as LiPF₆, is often not stable over cycles, and deterioration of the electrolyte leads to the formation of chemicals like hydrofluoric acid. Higher voltage and harsh charge/discharge conditions (e.g., high temperature and high charge/discharge rates) may further expedite the decomposition of the electrolyte. The hydrofluoric acid that is generated may in turn dissolve the active materials in the cathode, such as the metal oxides.

To improve the electrochemical performance of the battery, including, for example, enhancing the stability of lithium metal oxides used in the battery, the cathode materials may be coated with metal oxides, such as Al₂O₃ and ZrO₂. For example, such metal oxide coating may hamper lattice-constant changes, and protect cathode materials against chemicals, such as hydrofluoric acid, that may be generated.

Coating technologies such as Sol-gel, co-precipitation, chemical vapor deposition (CVD) and atomic layer deposition (ALD) have been explored for introducing metal oxide coating layers onto the surface of lithium metal oxides. Such technologies, however, often employ complicated, multi-step treatments. Further, such technologies may often lead to excess coating of metal oxide over the lithium metal oxides, which may lower the overall energy density of the cathode materials, and further block the charge transportation during charge and discharge.

Thus, what is needed in the art are lithium metal oxides suitable for use in lithium ion batteries that can improve capacity retention of such batteries. What is also needed in the art are alternative and improved methods to apply a metal oxide coating over lithium metal oxide used as an electrode material in lithium ion batteries.

### BRIEF SUMMARY

Provided herein are lithium metal oxide composites suitable for use as electrode materials in lithium ion batteries and that improve capacity retention in lithium-ion batteries. For example, such lithium metal oxide composites when used as cathode materials can help to minimize the effects of hydrofluoric acid, which may form from the deterioration of the lithium metal oxide and the electrolyte in the battery over cycles. Provided herein are also methods to produce lithium metal oxide composites made up of lithium metal oxide uniformly coated with a layer of metal oxide. In some variations, such metal oxide coatings may be of nano-scale thickness.

In some aspects, provided is a lithium metal oxide composite that includes lithium metal oxide coated with a metal oxide shell, wherein the metal oxide shell includes a plurality of metal oxide particles dispersed in a porous carbon matrix. In some embodiments, the metal oxide shell includes a plurality of metal oxide particles uniformly dispersed in a porous carbon matrix. In some variations, the lithium metal oxide may include, for example, lithium cobalt oxide (e.g., LiCoO₂), lithium manganese oxide (e.g., LiMnO₂, LiMnO₃, or LiMn₂O₄), lithium nickel oxide (e.g., LiNiO₂), and lithium manganese cobalt nickel oxides. In some variations, the metal oxide particles may include, for example, aluminum oxide (e.g., Al₂O₃, also known as alumina), zirconium oxide (e.g., ZrO₂), titanium oxide (e.g., TiO₂), and zinc oxide (e.g., ZnO).

Such lithium metal oxide composites may be prepared from a method that involves pyrolysis of metal-organic frameworks (MOFs). Thus, in some aspects, provided is a method for producing a lithium metal oxide composite that includes lithium metal oxide coated with a metal oxide shell, that includes: a) mechanochemically processing a metal-organic framework with lithium metal oxide to produce lithium metal oxide coated with a metal-organic framework shell; and b) pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix. In one variation, the plurality of metal oxide particles are uniformly dispersed in the porous carbon matrix. In some variations, the metal-organic framework may be produced by mechanochemically processing (i) one or more organic linking compounds, and (ii) one or more metal compounds. The metal-organic framework includes an open framework produced from the one or more organic linking compounds and the one or more metal compounds, wherein the open framework has one or more pores.

In other aspects, provided is a method for producing a lithium metal oxide composite that includes lithium metal oxide coated with a metal oxide shell, that includes: a) mechanochemically processing (i) one or more organic linking compounds, (ii) one or more metal compounds; and (iii) lithium metal oxide to produce lithium metal oxide coated with a metal-organic framework shell; and b) pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix. In one variation, the plurality of metal oxide particles are uniformly dispersed in the porous carbon matrix.

Provided herein is also a lithium metal oxide composite that includes lithium metal oxide coated with a metal oxide shell produced according to any of the methods described herein. Such lithium metal oxide composites may be used as an electrode material, such as a cathode material. Thus, in certain aspects, provided is also an electrode made up of a lithium metal oxide composite provided herein or produced according to the methods described herein.

Provided herein is also a battery that includes any of the electrode materials described herein, including the cathode materials described herein, and lithium ions.

### DESCRIPTION OF THE FIGURES

The present application can be understood by reference to the following description taken in conjunction with the accompanying figures.

FIG. 1 depicts an exemplary lithium metal oxide composite made up of lithium metal oxide coated with a metal oxide shell.

FIG. 2 depicts an exemplary lithium metal oxide having a metal-organic framework (MOF) layer that is pyrolyzed to form a lithium metal oxide composite made up of lithium metal oxide coated with a plurality of metal oxide particles dispersed in a porous carbon matrix.

FIGS. 3A, 3B and 3C depict exemplary processes to produce a lithium metal oxide composite (e.g., Al₂O₃@LiCoO₂) made up of lithium metal oxide (LiCoO₂) coated with a metal oxide shell (e.g., an Al₂O₃ shell).

FIGS. 4A-D depict four exemplary MOFs: ZIF-8 (FIG. 4A), HKUST-1 (FIG. 4B), MIL-53 (Al) (FIG. 4C), and NH₂-MIL-53 (Al) (FIG. 4D). The sphere in the middle of a MOF depicts the void space of the MOF.

FIG. 4E depicts a three-dimensional structure of MIL-53, where the octahedron represents Al³⁺, and the spheres represent carbon and oxygen atoms as labelled in the figure.

FIG. 5 depicts a capacity voltage profile of Al₂O₃@LiCoO₂ obtained from MIL-53@LiCoO₂ at various charging and discharging current densities.

FIGS. 6A-6E are graphs depicting cycling performance of Al₂O₃@LiCoO₂ obtained from MIL-53@LiCoO₂, at a current density at: 6.4 C or 900 mA g⁻¹ (FIG. 6A); 7.5 C or 1050 mA g⁻¹ (FIG. 6B); 8.6 C or 1200 mA g⁻¹ (FIG. 6C); 10 C or 1350 mA g⁻¹ (FIG. 6D); and 1 C or 1500 mA g⁻¹ (FIG. 6E).

FIG. 7 is a graph that compares cycling performance of: pyrolyzed MIL-53@LiCoO₂ (Material A); LiCoO₂ coated with alumina by mixing alumina and LiCoO₂ and then pyrolyzing such mixture (Material B); and LiCoO₂ without any coating (Material C).

FIG. 8 depicts an exemplary lithium-ion (Li-ion) battery, in which the cathode is made up of a lithium metal oxide composite made up of lithium metal oxide coated with a metal oxide shell. It should be understood that the size of the cathode and anode relative to the battery is not drawn to scale.

FIG. 9 depicts various methods, including milling, chemical vapor deposition (CVD) and atomic layer deposition, Sol-fel, and the methods described herein, to coat LiCoO₂ for use in a lithium ion battery. It should be understood that the size of the particles relative to the battery is not drawn to scale.

FIG. 10A is a SEM image of pristine LiCoO₂, which refers to LiCoO₂ that has not been coated with a MOF. FIG. 10B is a SEM image of MIL-53@LiCoO₂. FIG. 10C is a SEM image of MIL-53@LiCoO₂-600-Air, which refers to pyrolyzed MIL-53@LiCoO₂ prepared by heating the sample at 600° C. for 5 hours under air.

FIGS. 11A and 11B each provides an SEM image (top, left quadrant) and elemental mapping (top, right and bottom quadrants) of MIL-53@LiCoO₂-600-Air (FIG. 11A) and Al₂O₃ powder@LiCoO₂ (FIG. 11B).

FIG. 12A is a graph depicting the cycle-life performance of: (i) MIL-53@LiCoO₂-600-Air; and (ii) pure LiCoO₂ between 3.0V and 4.3V at a rate of 0.5 C. FIG. 12B is a graph depicting the discharge/charge profiles (corresponding to ascending and descending curves respectively with respect to increasing specific capacity) of MIL-53@LiCoO₂-600-Air. FIG. 12C is a graph depicting the cyclic voltammetry of MIL-53@LiCoO₂-600-Air. FIG. 12D is a graph depicting the electrochemical impedance of: (i) MIL-53@LiCoO₂-600-Air; (ii) Al₂O₃ powder@LiCoO₂-600-Air; (iii) aluminum isopropoxide@LiCoO₂-600-Air; and (iv) pure LiCoO₂ after four cycles. It should be understood that pure LiCoO₂ generally refers to LiCoO₂ that has not been coated with a MOF.

FIGS. 13A-13D are graphs depicting the cycle-life performance of: MIL-53@LiCoO₂-600-Air (FIG. 13A); pure LiCoO₂ (FIG. 13B); Al₂O₃ powder@LiCoO₂-600-Air (FIG. 13C); and aluminum isopropoxide@LiCoO₂-600-Air (FIG. 13D), between 3.0 V and 4.3 V at rates of 1C, 2C, 5C, 10C, 15C and 20C.

FIGS. 14A-14F are graphs depicting the cycle-life performance of: (i) MIL-53@LiCoO₂-600-Air; (ii) Al₂O₃ powder@LiCoO₂-600-Air; (iii) aluminum isopropoxide@LiCoO₂-600-Air; and (iv) pure LiCoO₂, between 3.0 V and 3.4 V at rates of 1C (FIG. 14A), 2C (FIG. 14B), 5C (FIG. 14C); 10C (FIG. 14D), 15C (FIG. 14E); and 20 C (FIG. 14F).

FIG. 15 is a graph depicting the cycle-life performance of: (i) MIL-53@LiCoO₂-600-Air; (ii) Al₂O₃ powder@LiCoO₂-600-Air; (iii) aluminum isopropoxide@LiCoO₂-600-Air; and (iv) pure LiCoO₂, between 3.0 V and 3.4 V at a rate of 5C.

FIGS. 16A and 16B are graphs depicting the cycle-life performance of: (i) MIL-53@LiCoO₂-600-Air; (ii) Al₂O₃ powder@LiCoO₂-600-Air; (iii) aluminum isopropoxide@LiCoO-600-Air₂; and (iv) pure LiCoO₂, between 3.0 V and 3.4 V at rates of 1C (FIG. 16A) and 5C (FIG. 16B) at 55° C. (328 K).

FIG. 17 is a graph depicting rate capability of different cathode materials at different C-rates over 3-4.5 V, where 1 C=140 mA g⁻¹.

FIG. 18 is a graph depicting the initial charge and discharge curves of uncoated NCM622 and NCM622 coated with NH₂-MIL-53 (“coated NCM622”) at 0.2 C (1 C=140 mA g⁻¹) over 3-4.5 V.

FIG. 19 is a graph depicting the initial discharge curves of uncoated NCM622 and coated NCM622 at 0.2 C (1 C=140 mA g⁻¹) over 3-4.5 V.

FIG. 20 is a graph depicting cycle performances of uncoated NCM622 and coated NCM622 at 1 C over 3-4.5 V (0.2 C at first 5 cycles, 1 C=140 mA g⁻¹).

FIG. 21 is a graph depicting cyclic voltammograms of coated NCM622 at a scan rate of 0.1 mVs⁻¹ over 3-4.5 V.

### DETAILED DESCRIPTION

The following description sets forth exemplary compositions, methods, parameters and the like. It should be recognized, however, that such description is not intended as a limitation on the scope of the present disclosure but is instead provided as a description of exemplary embodiments.

The present disclosure provides lithium metal oxide composites suitable for use as electrode materials in lithium ion batteries. For example, such lithium metal oxide composites may be suitable for use as cathode materials in lithium ion batteries. In some aspects, the lithium metal oxide composite includes lithium metal oxide coated with a metal oxide shell. In some variations, the metal oxide shell is made up of a plurality of metal oxide particles dispersed in a porous carbon matrix. In one variation, the plurality of metal oxide particles are uniformly dispersed in a porous carbon matrix.

Such lithium metal oxide composites may be prepared from metal-organic frameworks (MOFs). “Metal-organic frameworks” are compounds that include metal ions or clusters coordinated to organic molecules to form one-, two-, or three-dimensional structures that can be porous. Metal-organic frameworks suitable for use in the methods described herein may include, for example, aluminum-based metal-organic frameworks, zinc-based metal-organic frameworks, zirconium-based metal-organic frameworks, or magnesium-based metal-organic frameworks may be used in the methods described herein. It should be understood that “aluminum-based metal-organic frameworks” are compounds that include aluminum ions coordinating to organic molecules. Similarly, it should be understood that “zinc-based metal-organic frameworks” are compounds that include zinc ions coordinating to organic molecules. In one variation, the metal organic frameworks are zeolitic imidazolate frameworks (ZIFs). ZIFs are a class of MOFs that are topologically isomorphic with zeolites. ZIFs may be made up of tetrahedrally-coordinated metal ions connected by organic imidazole linkers (or derivatives thereof).

As used herein, “mechanochemical processing” refers to the use of mechanical energy to activate chemical reactions and structural changes. Mechanochemical processing may involve, for example, grinding or stirring. Such mechanochemical methods described herein are different from methods known in the art to generally synthesize metal-organic frameworks, which may typically involve hydrothermal and solvothermal synthesis.

The lithium metal oxide composites described herein and produced according to the methods provided herein may be suitable for use an electrode material, such as a cathode material, in a lithium ion battery. The use of such lithium metal oxide composites unexpectedly improves discharge capacity, as well as cycle performances and stability, of the battery.

The structure and properties of the lithium metal oxide composites, and the methods for producing such composites, and their uses are described in further detail below.

### Lithium Metal Oxide Composites

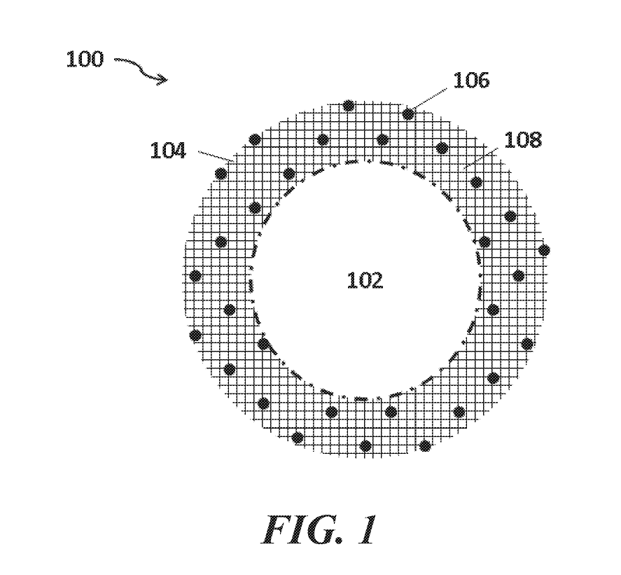

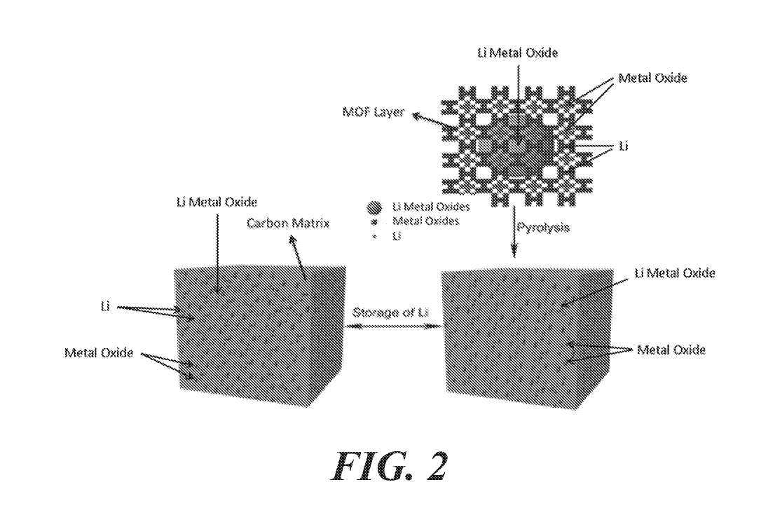

With reference to FIG. 1, in one exemplary embodiment, lithium metal oxide composite 100 has a lithium metal oxide core 102 and a metal oxide shell 104. The metal oxide shell is made up of a plurality of metal oxide particles dispersed in a porous carbon matrix. As depicted in FIG. 1, the plurality of metal oxide particles 106 are dispersed in a regular pattern, and are thus uniformly dispersed in porous carbon matrix 108.

For example, in certain variations, lithium metal oxide core 102 may be a lithium cobalt oxide (LiCoO₂) core; and metal oxide shell 104 may be an aluminum oxide (also referred to as alumina) shell. The aluminum oxide shell may be made up of a plurality of aluminum oxide particles dispersed in a porous carbon matrix. In one variation, the aluminum oxide shell may be made up of a plurality of aluminum oxide particles uniformly dispersed in a porous carbon matrix.

The lithium metal oxide composites described herein may be characterized by any methods or techniques known in the art. For example, the lithium metal oxide composites described herein may be characterized by electron dispersed spectroscopy.

Lithium Metal Oxide

With reference again to FIG. 1, core 102 may be made up of lithium cobalt oxide (LiCoO₂) as described above, or other lithium metal oxides. In some variations, the lithium metal oxide is made up of one or more metals selected from nickel (Ni), cobalt (Co), manganese (Mn), or iron (Fe), or any combinations thereof.

In certain embodiments, the lithium metal oxide is made up of one or more metals selected from nickel (Ni), cobalt (Co), manganese (Mn), or any combinations thereof. For example, in some variations, the lithium metal oxide is selected from LiCoO₂, LiMnO₂, LiMnO₃, LiMn₂O4, and LiNiO₂, or any combinations thereof. In other variations, the lithium metal oxide is selected from LiCoO₂, LiMnO₂, LiMnO₃, LiMn₂O₄, LiNiO₂, LiNi_{0.5}Mn_{1.5}O₄, and LiNiCoMnO₂, or any combinations thereof. In one variation, the lithium metal oxide is LiCoO₂. In another variation, the lithium metal oxide is LiNi_{0.5}Mn_{1.5}O₄. In yet another variation, the lithium metal oxide is LiNiCoMnO₂. In yet another variation, the lithium metal oxide is LiNi_{0.6}Co_{0.2}Mn_{0.2}O₂.

In other variations, the lithium metal oxide is a lithium manganese cobalt nickel oxide. For example, in one variation, the lithium metal oxide is LiNiₓCo_{y}Mn_{z}Oₐ, wherein: x is 0 to 3; y is 0 to 3; z is 0 to 3; and a is 0.1 to 10. In certain variations of the foregoing, at least one of x, y or z is greater than 0.

In certain variations, core 102 may be made up of any combinations of the lithium metal oxides described herein.

Metal Oxide Particles

With reference again to FIG. 1, shell 104 may be made up of aluminum oxide particles as described above, or other metal oxide particles. In some variations, the metal oxide particles are made up of one or more early transition metals. In certain variations, the metal oxide particles include one or more metals from Groups 3 to 12 in Periods 4 and 5 of the periodic table.

In certain variations, the metal oxide particles are made up of scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), or magnesium (Mg), or any combinations thereof. In one variation, the metal oxide particles are made up of aluminum (Al), zirconium (Zr), zinc (Zn), or titanium (Ti), or any combinations thereof. In another variation, metal oxide particles are aluminum oxide particles, zirconium oxide particles, titanium oxide particles, or zinc oxide particles, or any combinations thereof.

In certain variations, shell 104 may be made up of any combinations of the metal oxide particles described herein.

In certain embodiments of the lithium metal oxide composite described herein or provided according to the methods described herein, the metal oxide particles are uniformly dispersed within the porous carbon matrix. In some variations, “uniformly dispersed” refers to metal oxide particles spaced in a repeating pattern within a carbon matrix. In one variation, such metal oxide particles may be uniformly dispersed in a carbon matrix when a metal-organic framework shell is pyrolyzed.

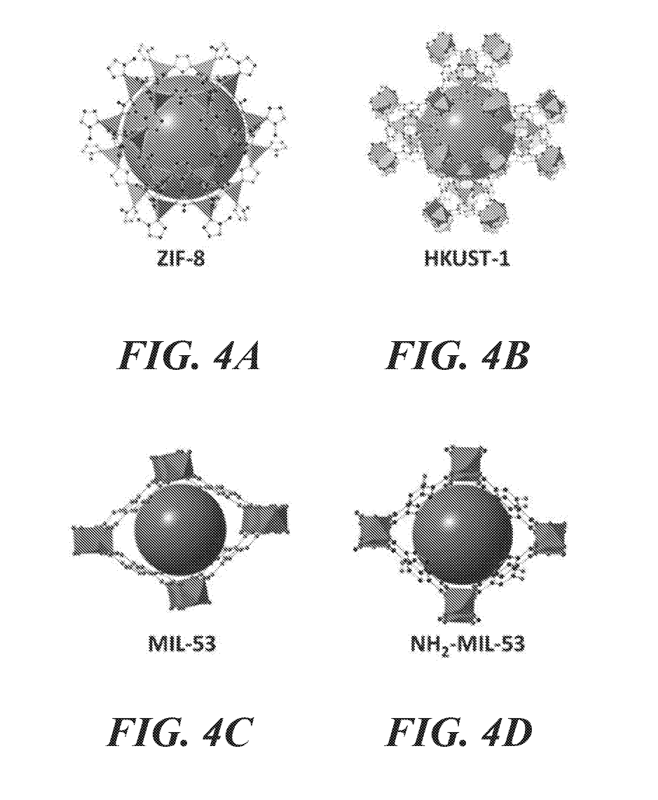

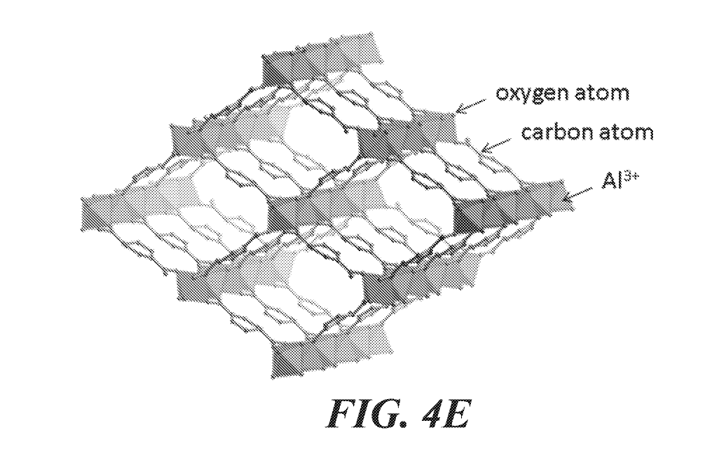

For example, in one variation, the lithium metal oxide composite is made up of LiCoO₂ coated with alumina uniformly dispersed within a carbon matrix, wherein the alumina and carbon matrix are formed from the pyrolysis of MIL-53. With reference to FIG. 4C, MIL-53 is an aluminum-based metal organic framework of 1,4-benzenedicarboxylic acid coordinating with aluminum. It is also generally known in the art that MIL-53 includes at least one of the following moiety:

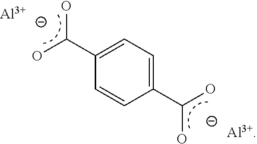

Further, a three-dimensional representation of MIL-53 is provided in FIG. 4E. It should be understood that, as depicted in FIG. 4E, the octahedrons represent Al³⁺; the spheres forming the 6-membered rings in the figure are the carbon atoms; and the spheres connecting the octahedrons (Al³⁺) with the carbon atoms are the oxygen atoms.

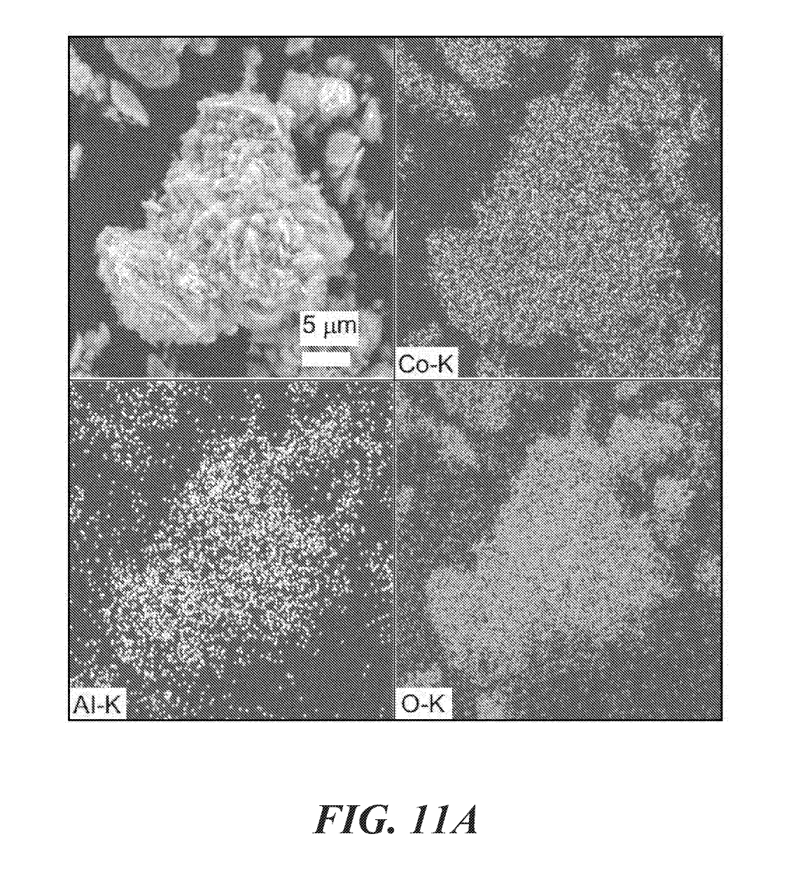

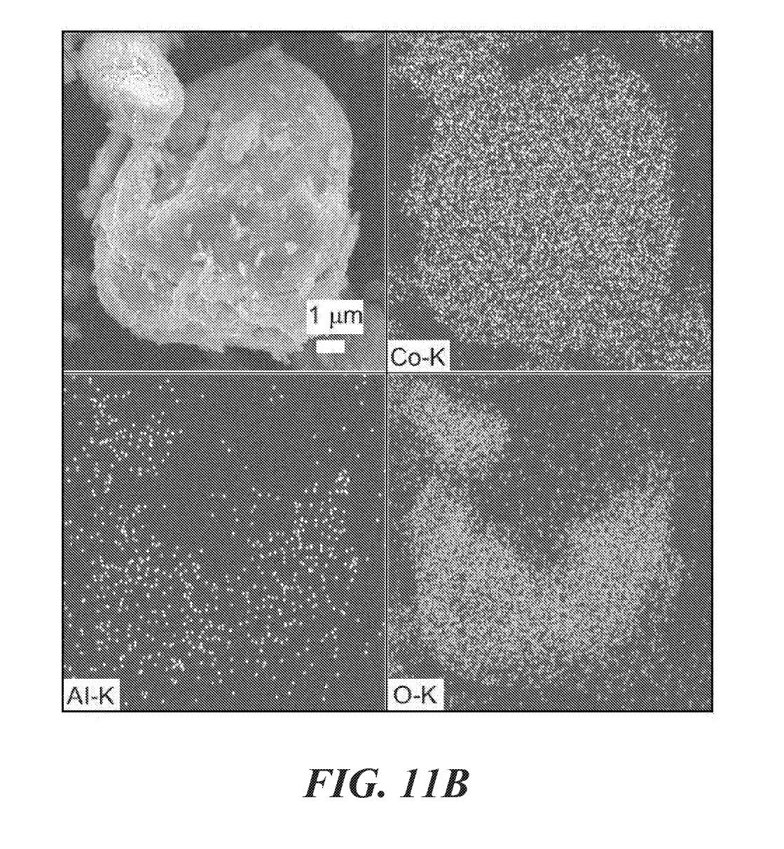

In certain embodiments of the lithium metal oxide composite described herein or provided according to the methods described herein, the metal oxide particles are dispersed to form a porous layer or film that covers the lithium metal oxide. In one embodiment, the metal oxide particles are dispersed to form a porous layer or film that completely covers the lithium metal oxide. For example, FIG. 11A provides elemental maps of pyrolyzed MIL-53@LiCoO₂ that indicate aluminum was dispersed to form a porous layer that completely covered the LiCoO₂. This is in contrast to FIG. 11B, which provides elemental maps of pyrolyzed Al₂O₃ powder@LiCoO₂ that indicate aluminum was dispersed to form a porous layer that only partially covered the LiCoO₂.

Without wishing to be bound by any theory, when MIL-53 is pyrolyzed, the aluminum ions may partially dissociate from the carboxylic groups and yield Al₂O₃ (alumina) embedded in a conductive porous carbon matrix that is derived from the 1,4-benzenedicarboxylic acid linkers of MIL-53. Further, the alumina may be produced at a sub-nano scale according to the methods described herein; and the alumina (in the form of Al³⁺) may evenly be distributed in nano scale within the carbon matrix formed. When the methods described herein are employed, conglomeration is not typically observed, whereas severe clustering is typically observed when alumina is coated onto the lithium metal oxide using techniques and methods presently known in the art.

In some variations, the carbon matrix produced from pyrolyzing MIL-53 may be depicted as having at least one moiety as follows:

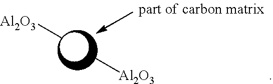

More generally, in other variations, the carbon matrix produced from pyrolyzing metal-organic frameworks may be depicted as having at least one moiety as follows:

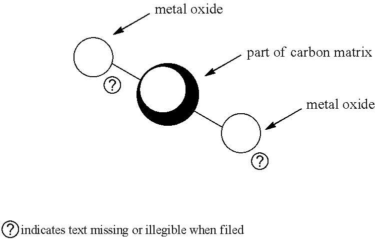

In certain variations, the carbon matrix embedded with metal oxide as described above is produced from pyrolyzing aluminum-based metal-organic frameworks, zinc-based metal-organic frameworks, zirconium-based metal-organic frameworks, or magnesium-based metal-organic frameworks, or any combinations thereof. In certain variations, the carbon matrix embedded with metal oxide as described above is produced from pyrolyzing zeolitic imidazolate frameworks. In certain variation, the metal-organic frameworks may be selected from, for example, MIL-53, MOF-519, MOF-520, MOF-5, MOF-177, ZIF-8, ZIF-11, MOF-74, HKUST-1, and NH₂-MIL-53. In one variation, the metal-organic framework is selected from MIL-53, MOF-519, MOF-520, MOF-5, MOF-177, ZIF-8, ZIF-11, and MOF-74. In one variation, the metal-organic framework is MIL-53. In another variation, the metal-organic framework is NH₂-MIL-53. Any combinations of the metal-organic frameworks described herein may be used.

In some variations, the metal oxide particles are dispersed in the porous carbon matrix within a distance between about 0.5 nm to 5 nm apart. In other variations, the metal oxide particles are dispersed in the porous carbon matrix within a distance of about 0.5 nm, about 5 nm, about 10 nm, about 20 nm or about 50 nm apart.

Porous Carbon Matrix

With reference again to FIG. 1, porous carbon matrix 108 is obtained by pyrolyzing lithium metal oxide coated with a metal-organic framework shell. The carbon matrix may generally be described as a carbon framework that is derived from pyrolysis of a metal-organic framework. In some variations, such carbon framework is an amorphous carbon framework. In some variations, such carbon matrix is porous.

As used herein, “pores” of the carbon matrix refers to the cavities and/or channels of the carbon matrix. Pore size can be determined by any methods or techniques known in the art. For example, pore size can be calculated using density functional theory (DFT) or X-ray crystallography (e.g., single crystal data).

In some variations, the carbon matrix has one pore type, which the radii of the pores are substantially identical. For example, a carbon matrix having one pore type may include a carbon matrix formed from pyrolyzing metal-organic frameworks such as ZIF-8 and MIL-53. In other variations, the carbon matrix has two or more pore types. Such carbon matrices may be formed from pryolyzing metal-organic frameworks having two or three different pore types, such as HKUST-1 and MOF-5. Examples of MOFs are depicted in FIGS. 4A-4D.

In some embodiments, the carbon matrix has an average pore size of less than 20 nm, less than 10 nm, or less than 5 nm; or between 1 and 20 nm.

The pores of the carbon matrix may be interconnected by apertures, which may be in the form of channels and/or windows. As used herein, “aperature diameter” refers to the largest diameter of the aperatures in the carbon matrix. Aperature diameter may be determined using any suitable methods or techniques known in the art. For example, the aperature diameter of the carbon matrix may be determined by nitrogen gas adsorption.

In some embodiments, the carbon matrix has an average aperature diameter of less than 20 nm, less than 10 nm, or less than 5 nm; or between 1 and 20 nm.

The methods for obtaining the lithium metal oxide composites are described in further detail below.

### Methods of Producing Lithium Metal Oxide Composites

Provided herein are also methods for producing a lithium metal oxide composite that is made up of lithium metal oxide coated with a metal oxide shell. In some aspects, the lithium metal oxide composite is produced by:

mechanochemically processing a metal-organic framework (MOF) with lithium metal oxide to produce lithium metal oxide coated with a metal-organic framework shell; and

pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix formed from the pyrolysis of the metal-organic framework shell.

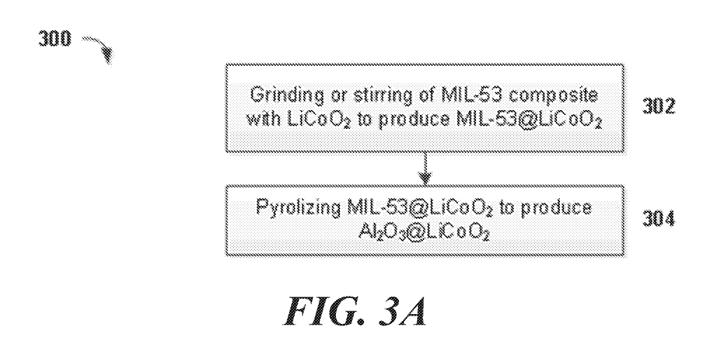

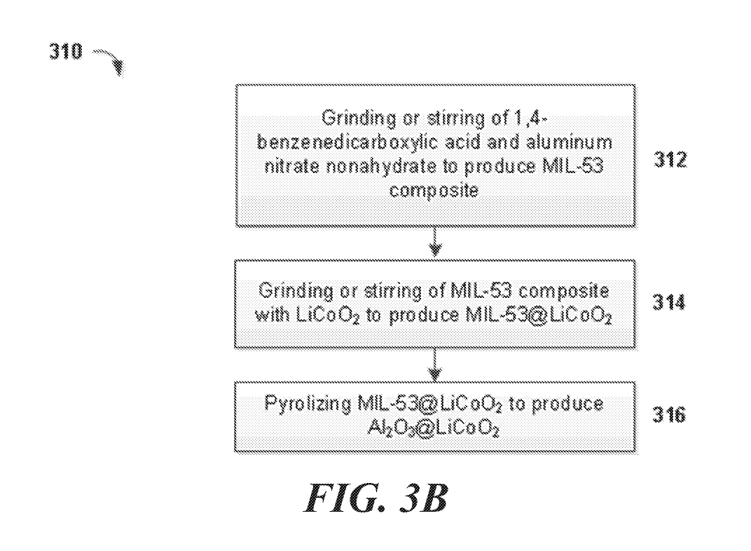

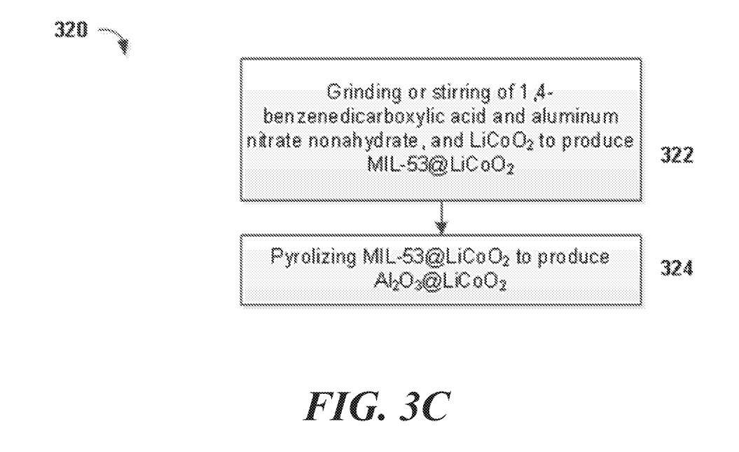

For example, with reference to FIG. 3A, process 300 depicts an exemplary process to produce Al₂O₃@LiCoO₂, which refers to LiCoO₂ coated with alumina, from MIL-53. It should generally be understood that “metal oxide@lithium metal oxide” refers to lithium metal oxide coated with a metal oxide. With reference again to FIG. 3A, step 302 involves the mechanochemical processing (e.g., grinding or stirring) of MIL-53 with LiCoO₂ to produce MIL-53@LiCoO₂, which refers to LiCoO₂ coated with MIL-53. It should generally be understood that “metal-organic framework@lithium metal oxide” refers to lithium metal oxide coated with a metal-organic framework shell. With reference again to FIG. 3A, step 304 involves pyrolyzing MIL-53@LiCoO₂ to oxidize MIL-53, thereby forming alumina dispersed within a porous carbon matrix.

With reference again to FIG. 3A, in some variations, MIL-53 in step 302 may be obtained from any commercially available sources, or produced by any methods known in the art. Thus, in some embodiments, the metal-organic framework may be obtained from any commercially available sources or produced by any methods known in the art. See e.g., Chem. Eur. J. 2004, 10, 1373-1382; Chem. Comm., 2003, 2976-2977.

In certain embodiments, the metal-organic framework may be produced by: mechanochemically processing (i) one or more organic linking compounds, and (ii) one or more metal compounds. The mechanochemical processing may involve grinding or stirring. In one variation, provided is a method to produce a metal-organic framework by grinding a mixture that includes (i) one or more organic linking compounds, and (ii) one or more metal compounds. In another variation, provided is a method to produce a metal-organic framework by stirring a mixture that includes (i) one or more organic linking compounds, and (ii) one or more metal compounds. The mechanochemically processing (e.g., grinding or stirring) may be performed in a liquid medium. Additionally, the mechanochemically processing may be performed without the addition of external heat.

In another example, with reference to FIG. 3B, process 310 depicts another exemplary process to produce Al₂O₃@LiCoO₂ from MIL-53. Step 312 involves the mechanochemical processing (e.g., grinding or stirring) of 1,4-benzenedicarboxylic acid and aluminum nitrate nonahydrate to produce a MIL-53 composite. Step 314 involves the mechanochemical processing (e.g., grinding or stirring) of such MIL-53 composite with LiCoO₂ to produce MIL-53@LiCoO₂. Then, step 316 involves pyrolyzing MIL-53@LiCoO₂ to oxidize MIL-53, thereby forming alumina dispersed within a porous carbon matrix.

As described above, the mechanochemically processing of the metal-organic framework with lithium metal oxide produces lithium metal oxide coated with a metal-organic framework shell. The mechanochemical processing may involve grinding or stirring. In one variation, provided is a method to produce lithium metal oxide coated with a metal-organic framework shell, by grinding a mixture that includes (i) a metal-organic framework, and (ii) lithium metal oxide. In another variation, provided is a method to produce lithium metal oxide coated with a metal-organic framework shell, by stirring a mixture that includes (i) a metal-organic framework, and (ii) lithium metal oxide. The mechanochemically processing (e.g., grinding or stirring) may be performed in a liquid medium. Additionally, the mechanochemically processing may be performed without the addition of external heat.

In certain aspects, the methods to produce lithium metal oxide coated with a metal-organic framework shell may be performed in “one-pot”, such that (i) one or more organic linking compounds, (ii) one or more metal compounds, and (iii) lithium metal oxide to produce the lithium metal oxide composite are mechanochemically processed together in the same step. The mechanochemical processing may involve grinding or stirring. Thus, in one aspect, provided is a the method that involves grinding a mixture that includes (i) one or more organic linking compounds, (ii) one or more metal compounds, and (iii) lithium metal oxide to produce lithium metal oxide coated with a metal-organic framework shell described herein. In another aspect, provided is a the method that involves stirring a mixture that includes (i) one or more organic linking compounds, (ii) one or more metal compounds, and (iii) lithium metal oxide to produce lithium metal oxide coated with a metal-organic framework shell. The mechanochemically processing (e.g., grinding or stirring) may be performed in a liquid medium. Additionally, the mechanochemically processing may be performed without the addition of external heat.

The lithium metal oxide coated with a metal-organic framework shell can then be heated (e.g., pyrolyzed) to produce a lithium metal oxide composite made up of lithium metal oxide coated with a metal oxide shell. Thus, in certain aspects, the lithium metal oxide coated with a metal-organic framework shell may be produced by:

mechanochemically processing (i) one or more organic linking compounds, (ii) one or more metal compounds, and (iii) lithium metal oxide to produce lithium metal oxide coated with a metal-organic framework shell; and

pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix formed from the pyrolysis of the metal-organic framework shell.

In yet another example, with reference to FIG. 3C, process 320 depicts another exemplary process to produce Al₂O₃@LiCoO₂ from MIL-53. Step 322 involves the mechanochemical processing (e.g., grinding or stirring) of 1,4-benzenedicarboxylic acid, aluminum nitrate nonahydrate, and LiCoO₂ to produce MIL-53@LiCoO₂. Step 324 involves pyrolyzing MIL-53@LiCoO₂ to oxidize MIL-53, thereby forming alumina dispersed within a porous carbon matrix.

Mechanochemically processing may be employed to produce any type of metal-organic frameworks. For example, in some embodiments, mechanochemically processing is used to produce aluminum-based metal-organic frameworks, zinc-based metal-organic frameworks, zirconium-based metal-organic frameworks, magnesium-based metal-organic frameworks. In one embodiment, mechanochemically processing is used to produce zeolitic imidazolate frameworks. In one variation, mechanochemically processing is used to produce metal-organic frameworks such as MIL-53, MOF-519, MOF-520, MOF-5, MOF-177, ZIF-8, ZIF-11, and MOF-74.

Grinding

Any suitable methods and techniques known in the art may be used for grinding. In one embodiment of the methods described herein, the grinding may be performed using a ball mill. For example, a high-energy ball mill machine may be used. The frequency of the ball mill machine may vary, and is expressed as the rate at which the mixture will be rotated and/or shaken with the balls of the machine. In one variation of the method, grinding is performed using a ball mill at a frequency of between 5 Hz and 60 Hz, between 10 Hz and 50 Hz, between 10 Hz and 30 Hz, or between 10 Hz and 20 Hz. In another variation, grinding is performed using a ball mill operating between 600 rmp to 1200 rmp.

In the mechanochemical methods, in one variation, the grinding of (i) one or more organic linking compounds, and (ii) one or more metal compounds may produce intrinsic heat, which may help with the formation of a metal-organic framework. In another variation, the grinding of (i) a metal-organic framework, and (ii) lithium metal oxide may produce intrinsic heat, which may help with the formation of lithium metal oxide coated with a metal-organic framework shell. In yet another variation, the grinding of (i) one or more organic linking compounds, (ii) one or more metal compounds, and (iii) lithium metal oxide may produce intrinsic heat, which may help in the formation of lithium metal oxide coated with a metal-organic framework shell.

The intrinsic heat may, for example, cause the reactions described above to take place at a temperature between room temperature and 60° C., between room temperature and 55° C., between room temperature and 50° C., between room temperature and 55° C., between room temperature and 40° C., between room temperature and 45° C., or between room temperature and 30° C.; or at about room temperature. In certain embodiments, the metal-organic framework or the metal-organic framework shell (as the case may be) is produced at a temperature below 60° C., below 55° C., below 50° C., below 55° C., below 40° C., below 45° C., or below 30° C.; or at about room temperature. In some embodiments of the method, grinding is performed without external heating.

The amount of time used for the grinding also may impact the formation of the metal-organic framework. In some embodiments of the method, the grinding is performed for at least 1 minute, at least 5 minutes, at least 10 minutes, at least 20 minutes, at least 30 minutes, at least 60 minutes, at least 120 minutes, at least 240 minutes, or at least 480 minutes; or between 5 minutes and 1000 minutes, between 5 minutes and 720 minutes, or between 5 minutes and 120 minutes.

In some embodiments, the grinding may be performed under inert atmosphere. For example, the grinding of the mixture may be performed in the presence of an inert gas, such as argon or nitrogen. The grinding under inert atmosphere may help reduce the impurities produced. In certain embodiments, grinding is performed in the absence of solvent.

Stirring

Any suitable methods and techniques known in the art may be used for stirring. In some embodiments, stirring may be performed in a liquid medium, as discussed in further detail below. Stirring may be performed using any suitable apparatus known in the art. For example, stirring may be carried out using a stir bar or a mechanical stirrer (e.g., paddle, stir motor).

In the mechanochemical methods, in one variation, the stirring of (i) one or more organic linking compounds, and (ii) one or more metal compounds may produce intrinsic heat, which may help with the formation of a metal-organic framework. In another variation, the stirring of (i) a metal-organic framework, and (ii) lithium metal oxide may produce intrinsic heat, which may help with the formation of lithium metal oxide coated with a metal-organic framework shell. In yet another variation, the stirring of (i) one or more organic linking compounds, (ii) one or more metal compounds, and (iii) lithium metal oxide may produce intrinsic heat, which may help in the formation of lithium metal oxide coated with a metal-organic framework shell.

In certain embodiments, the composite is produced at a temperature below 30° C., or at about room temperature. In some embodiments of the method, stirring is performed without external heating.

The amount of time used for the stirring also may impact the formation of the metal-organic framework. In some embodiments of the method, the stirring is performed for at least 1 minute, at least 5 minutes, at least 10 minutes, at least 20 minutes, at least 30 minutes, at least 60 minutes, at least 120 minutes, at least 240 minutes, or at least 480 minutes, or between 5 minutes and 1000 minutes, between 5 minutes and 720 minutes, or between 5 minutes and 120 minutes.

In some embodiments, the stirring may be performed under inert atmosphere. For example, the stirring of the mixture may be performed in the presence of an inert gas, such as argon or nitrogen. The stirring under inert atmosphere may help reduce the impurities produced.

Organic Linking Compounds

As used herein, “linking compound” refers to a monodentate or a bidendate compound that can bind to a metal or a plurality of metals. Various organic linking compounds may be used in the methods described herein. The organic linking compounds may be obtained from any commercially available sources, or prepared using any methods or techniques generally known in the art.

Organic linking compounds known in the art suitable for forming metal-organic frameworks may also be used. It should be understood that the types of organic linking compounds selected for use in the methods will determine the type of metal-organic framework formed in the composite.

In other embodiments of the method, the organic linking compound used in the method may be an aryl substituted with at least one carboxyl moiety, or a heteroaryl substituted with at least one carboxyl moiety. In certain embodiments, the organic linking compound used in the method may be an aryl with at least one phenyl ring substituted with a —COOH moiety, or a heteroaryl with at least pyridyl ring substituted with a —COOH moiety. In certain embodiments, the organic linking compound is an aryl with 1 to 5 phenyl rings, wherein at least one phenyl ring is substituted with a —COOH moiety, or a heteroaryl with 1 to 5 pyridyl rings, wherein at least pyridyl ring is substituted with a —COOH moiety.

When aryl includes two or more phenyl rings, the phenyl rings may be fused or unfused. When heteroaryl includes two or more pyridyl rings, or at least one pyridyl ring and at least one phenyl ring, such rings may be fused or unfused. It should be understood that aryl does not encompass or overlap in any way with heteroaryl. For example, if a phenyl ring is fused with or connected to a pyridyl ring, the resulting ring system is considered heteroaryl.

Examples of organic linking compounds suitable for use in the mechanochemical methods for producing metal-organic frameworks may include:

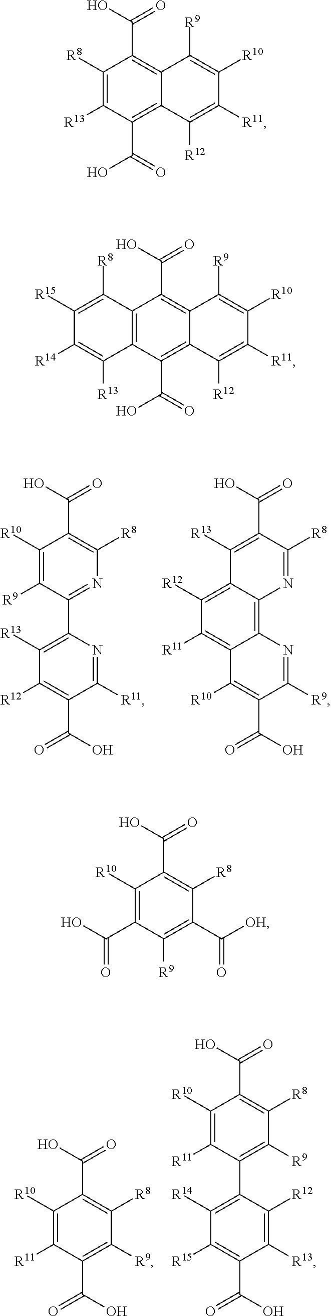

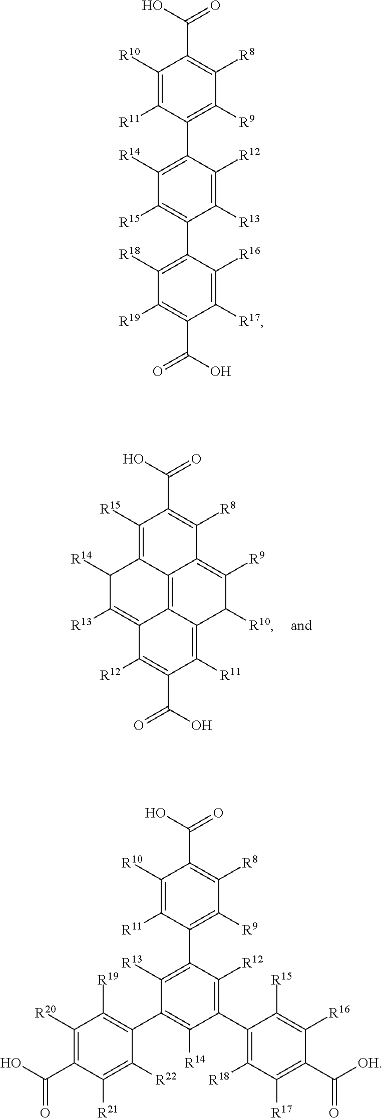

wherein:

each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (When present) is independently selected from the group consisting of H, NH₂, CN, OH, ═O, ═S, Br, Cl, I, F,

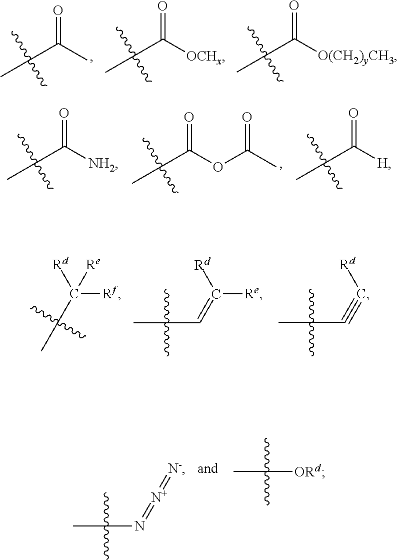

x and y (when present) is independently 1, 2 or 3; and

each R^{d}, R^{e} and R^{f} (when present) is independently H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, or Sn(SH)₄.

In certain embodiments, each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (when present) is H.

In certain embodiments of the method, the organic linking compound may be an unsubstituted or substituted phenyl compound. The phenyl may, in one embodiment, be substituted with one or more carboxyl substituents. Examples of such organic linking compounds include trimesic acid, terephthalic acid, and 2-amino benzyl dicarboxylic acid.

In certain embodiments of the method where the metal-organic framework is a zeolitic imidazolate framework (ZIF), the organic linking compound used in the method may be a monocyclic five-membered heteroaryl having at least two nitrogen atoms, wherein two of the nitrogen atoms are configured in the 1- and 3-positions of the monocyclic five-membered ring. It should be understood that such monocyclic five-membered ring (which may be optionally substituted) having nitrogen atoms at the 1- and 3-positions of the ring include:

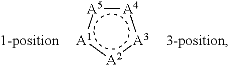

wherein A¹ and A³ are independently N or NH; and A², A⁴ and A⁵ are independently C, CH, N or NH (to the extent that such ring system is chemically feasible). In other embodiments of the method where the organic framework of the composite produced is ZIF, the organic linking compound used in the method may also be a bicyclic ring system made up of at least one five-membered ring having at least two nitrogen atoms, wherein two of the nitrogen atoms are configured in the 1- and 3-positions of the five-membered ring. The bicyclic ring system may further include a second five-membered ring or a six-membered ring fused to the first five-membered ring. It should be understood that such bicyclic ring system (which may be optionally substituted) made up of at least one five-membered ring having nitrogen atoms are configured in the 1- and 3-positions of the five-membered ring may include, for example:

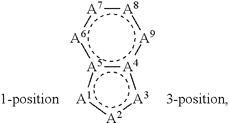

wherein A¹ and A³ are independently N or NH; and A², A⁴-A⁹ are independently C, CH, N or NH (to the extent that such ring system is chemically feasible).

In certain embodiments of the method where the metal-organic framework is a zeolitic imidazolate framework (ZIF), the organic linking compound is unsubstituted or substituted imidazole, unsubstituted or substituted benzimidazole, unsubstituted or substituted triazole, unsubstituted or substituted benzotriazole, or unsubstituted or substituted purine (e.g., unsubstituted or substituted guanine, unsubstituted or substituted xanthine, or unsubstituted or substituted hypoxanthine).

Examples of organic linking compounds suitable for use in the mechanochemical methods for producing ZIF may include:

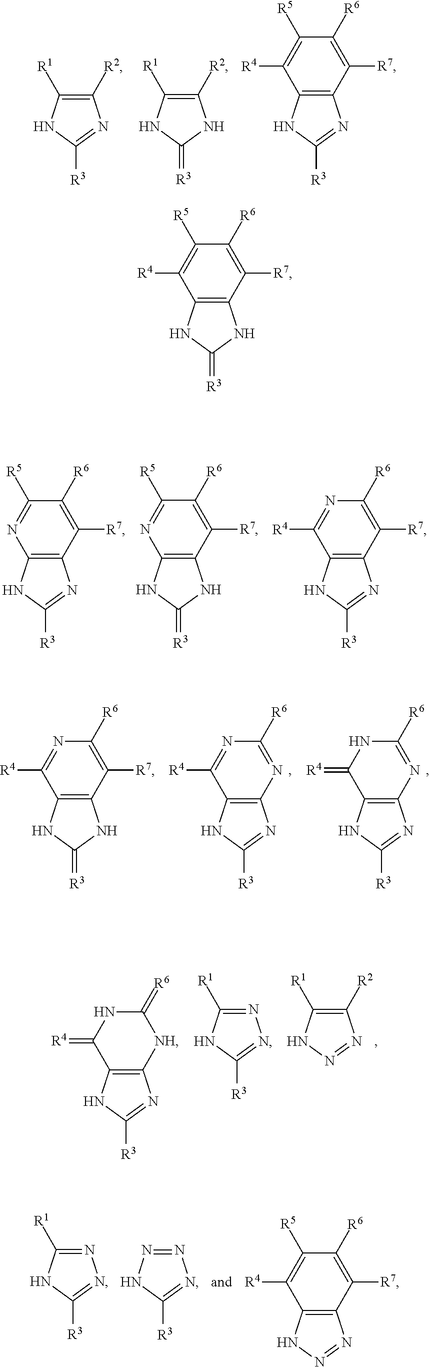

wherein:

each R¹, R², R³, R⁴, R⁵, R⁶ and R⁷ (when present) is independently selected from the group consisting of H. NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, As(SH)₃, CH(R^{a}SH)₂, C(R^{a}SH)₃, CH(R^{a}NH₂)₂, C(R^{a}NH₂)₃, CH(R^{a}OH)₂, C(R^{a}OH)₃, CH(R^{a}CN)₂, C(R^{a}CN)₃,

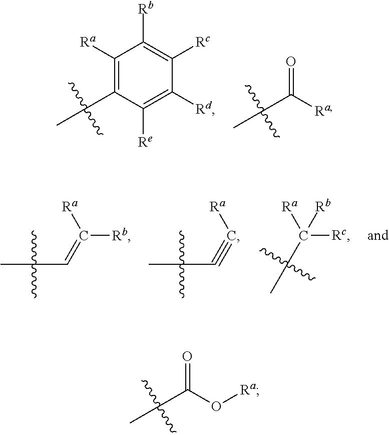

and

each R^{a}, R^{b}, and R^{c} (when present) is independently selected from the group consisting of H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, and As(SH)₃.

In certain embodiments, each R¹, R², R³, R⁴, R⁵, R⁶ and R⁷ (when present) is independently H or

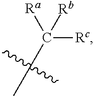

wherein each R^{a}, R^{b}, and R^{c} is H or alkyl (e.g. C₁₋₂₀ alkyl, or C₁₋₁₀ alkyl, or C₁₋₄ alkyl).

In other embodiments, the organic linking compound may have a structure of formula:

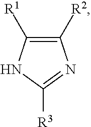

wherein:

each R¹ and R² is independently hydrogen, aryl (e.g., C₅₋₂₀ aryl, or C₅₋₆ aryl), alkyl (e.g. C₁₋₂₀ alkyl, or C₁₋₁₀ alkyl, or C₁₋₄ alkyl), halo (e.g., Cl, F, Br, or I), cyano, or nitro; or R¹ and R² are taken together with the carbon atoms to which they are attached to form a five- or six-membered heterocycle comprising 1, 2, or 3 nitrogen atoms; and

R³ is hydrogen or alkyl.

In certain embodiments, each R¹ and R² is hydrogen. In certain embodiments, each R¹ and R² is independently alkyl (e.g. C₁₋₂₀ alkyl, or C₁₋₁₀ alkyl, or C₁₋₄ alkyl). In certain embodiments, R³ is hydrogen. In certain embodiments, R³ is alkyl (e.g. C₁₋₂₀ alkyl, or C₁₋₁₀ alkyl, or C₁₋₄ alkyl). In one embodiment, R³ is methyl. In certain embodiments, each R¹ and R² is independently alkyl; and R³ is hydrogen. In one embodiment, each R¹ and R² is methyl; and R³ is hydrogen. In certain embodiments, each R¹ and R² is hydrogen; and R³ is alkyl. In one embodiment, each R¹ and R² is hydrogen; and R³ is methyl. In yet another embodiment of the composite, each R¹, R² and R³ is hydrogen.

In certain embodiments, the organic linking compound may have a structure selected from:

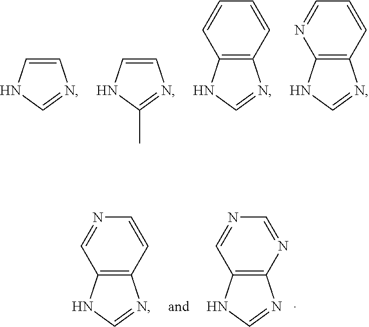

In certain embodiments, the organic linking compound may be an unsubstituted or substituted imidazole. Examples of such organic linking compounds include 2-alkyl imidazole (e.g., 2-methyl imidazole). In certain embodiments, the organic linking compound may an imidazole or imidazole derivative, including for example heterocyclic rings such as unsubstituted imidazole, unsubstituted benzimidazole, or imidazole or benzimidazole substituted with alkyl (e.g. C₁₋₁₀ alkyl, or C₁₋₁₀ alkyl, or C₁₋₄ alkyl), nitro, cyano, or halo (e.g., Cl, F, Br, or I) groups, wherein one or more carbon atoms on the imidazole or benzimidazole may be replaced with a nitrogen atom (to the extent chemically feasible).

Metal Compounds

Metal ions can be introduced into the open framework via coordination or complexation with the functionalized organic linking moieties (e.g., imine or N-heterocyclic carbene) in the framework backbones or by ion exchange. The metal ions may be from metal compounds, including metal salts and complexes. Various metal compounds, including metal salts and complexes, may be used in the methods described herein. The metal compounds, including metal salts and complexes, may be obtained from any commercially available sources, or prepared using any methods or techniques generally known in the art.

The metal compound may, for example, be selected from a zinc compound, a copper compound, an aluminum compound, a copper compound, an iron compound, a manganese compound, a titanium compound, a zirconium compound, or other metal compounds having one or more early transition metals. In one variation, the metal compound may include one or more metals selected from Sc, Ti, V, Cr, Mn, Fe, Co, Ni, Cu, and Zn. In one embodiment, the metal compound is zinc oxide (ZnO), copper acetate (Cu(Ac)₂), aluminium acetate (Al(Ac)₃), zinc acetate (Zn(OAc)₂), or any combination thereof. It should be understood that salts and complexes of such metal compounds may also be used. For example, a dihydrate of zinc acetate, Zn(OAc)₂.2H₂O, may be used as the metal compound in the methods described herein.

The metal compound is made up one or more metal ions. In some variations, the metal ions may be transition metal ions. The metal ion(s) of the metal compound may be one that prefers tetrahedral coordination. One such example is Zn²⁺. Thus, in one variation, the metal compound has a Zn²⁺. Other suitable metal ions of the metal compound include, for example, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, T³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, or any combinations thereof. In some embodiments, the metal compound has one or more metal ions selected from Zn²⁺, Cu²⁺, Cu⁺, Al³⁺, Cu²⁺, Cu⁺, Fe³⁺, Fe²⁺, Mn³⁺, Mn²⁺, Ti⁴⁺, and Zr⁴⁺. In one embodiment, the metal compound has one or more metal ions selected from Zn²⁺, Cu²⁺, Cu⁺, Al³⁺, Cu²⁺, and Cu⁺.

In some variations, the metal ions may be one or more early transition metal ions. In certain variations, the metal ions are one or more metal ions from Groups 3 to 12 in Periods 4 and 5 of the periodic table. In certain variations, the metal oxide ions are selected from scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), or magnesium (Mg) ions, or any combinations thereof. In one variation, the metal ions are aluminum (Al), zirconium (Zr), zinc (Zn), or titanium (Ti) ions. In another variation, metal ions are aluminum ions, zirconium ions, titanium ions, or zinc ions, or any combinations thereof. In certain variations, the metal ions may be early transition metal ions, Al³⁺, or Mg²⁺.

The metal compound may, in certain instances, have one or more counterions. Suitable counterions may include, for example, acetate, nitrates, chloride, bromides, iodides, fluorides, and sulfates.

Pyrolyzing

Any suitable methods and techniques known in the art may be used for pyrolysis. In one embodiment of the methods described herein, the lithium metal oxide coated with a metal-organic framework shell may be heated at a temperature of at least 100° C., or at least 200° C., or between 100° C. and 600° C., or between 600° C. and 1500° C., to produce a lithium metal oxide composite comprising lithium metal oxide coated with a metal oxide shell.

The metal ions described above can be introduced into the open frameworks via complexation with the organic linking moieties in the framework backbones or by ion exchange.

### Electrodes

The lithium metal oxide composites provided herein or produced according to the methods described herein may be suitable for use as electrode materials in batteries, such as Li-ion batteries. In one aspect, provided is an electrode comprising: a lithium metal oxide composite (or a plurality of such composites) provided herein or produced according to any of the methods described herein, carbonaceous material, and binder. In some embodiments of the electrode, the lithium metal oxide composite is at least 25 wt % or at least 30 wt % of the electrode. In one variation, the electrode is a cathode. In another variation, the electrode is an anode. In yet another variation, both the cathode and the anode of a lithium-ion battery may be made up of the lithium metal oxide composites provided herein or produced according to any of the methods described herein.

In some embodiments, provided is a cathode that includes: a lithium metal oxide composite (or a plurality of such composites) provided herein or produced according to any of the methods described herein, and binder.

Any binders known in the art suitable for use in preparing electrodes of batteries, including for example Li-ion batteries, may be used. For example, the binder may be poly(vinylidene fluoride) (PVdF), carboxyl methyl cellulose (CMC), and alginate, or any combinations thereof.

In some variations, the cathode further includes additional carbonaceous material. Such additional carbonaceous material may include, for example, carbon black.

Any suitable methods and techniques known in the art may be employed to prepare the electrodes. See e.g., Hong Li et al. Adv. Mater. 2009, 21, 4593-460.

It should be understood that the lithium metal oxide composites provided herein or produced according to any of the methods described herein functions as active material in the electrode. The lithium metal oxide composite in the electrode may be characterized by one or more properties, including for example charge/discharge capacity, decay rate, retention rate, and coulombic efficiency. One of skill in the art would recognize the suitable methods and techniques to measure capacity of the composite used in an electrode. For example, capacity may be measured by standard discharging and charging cycles, at standard temperature and pressure (e.g., 25° C. and 1 bar). See e.g., Juchen Guo, et al., J. Mater. Chem., 2010, 20, 5035-5040.

Discharge Capacity

As used herein, “discharge capacity” (also referred to as specific capacity) refers to the capacity measured to discharge the cell. Discharge capacity can also be described as the amount of energy the composite contains in milliamp hours (mAh) per unit weight.

In some embodiments, the lithium metal oxide composites provided herein or produced according to any of the methods described herein have an average discharge capacity over an initial 10 cycles at 1C of at least 100 mAh/g, or at least 110 mAh/g, or at least 120 mAh/g, or at least 130 mAh/g, or at least 140 mAh/g, or at least 150 mAh/g. In some embodiments, the lithium metal oxide composites provided herein or produced according to any of the methods described herein have an average discharge capacity over an initial 10 cycles at 3 C of at least 90 mAh/g, or at least 100 mAh/g, or at least 110 mAh/g, or at least 120 mAh/g, or at least 130 mAh/g, or at least 140 mAh/g, or at least 150 mAh/g, or at least 160 mAh/g, or at least 170 mAh/g. For example, in certain embodiments, the lithium metal oxide composites provided herein or produced according to the methods described herein have an average discharge capacity over an initial 10 cycles of: (i) at least 110 mAh/g at 1C; and (ii) at least 90 mAh/g at 3C.

For example, in one example, a LiCoO₂ composite coated with alumina dispersed within a carbon matrix, wherein such coating was formed from pyrolysis of MIL-53, provided herein or produced according to the methods described herein has an average discharge capacity over an initial 10 cycles of: (i) at least 110 mAh/g at 1C; and (ii) at least 90 mAh/g at 3C.

It should be understood that 1C and 3C, for example, refers to different charging rates. The charging rate is often denoted as C or C-rate, and generally refers to a charge or discharge rate equal to the capacity of a battery in one hour. In some variations, the C-rate is determined based on the uncoated lithium metal oxide. Any techniques known in the art may be used to determine the charging rate.

In some aspects, provided herein is a cathode material, e.g., for use in a lithium ion battery, that includes lithium metal oxide coated with a metal-organic framework shell. The lithium metal oxide coated with a metal-organic framework shell may be pyrolyzed to form lithium metal oxide coated with a metal oxide shell. Thus, in other aspects, provided is a cathode material, e.g., for use in a lithium ion battery, that includes lithium metal oxide coated with a metal oxide shell, wherein the metal oxide shell is made up of a plurality of metal oxide particles dispersed in a porous carbon matrix, for use as the cathode material.

In some variations, the cathode materials provided herein may have a discharge capacity over an initial 5 cycles of at least 110 mAh/g, or at least 120 mAh/g, or at least 130 mAh/g, or at least 135 mAh/g, or at least 140 mAh/g, or at least 145 mAh/g, or at least 150 mAh/g, or between 110 mAh/g and 220 mAh/g, or between 120 mAh/g and 220 mAh/g, or between 120 mAh/g and 200 mAh/g, or between 120 mAh/g and 140 mAh/g, or between 130 mAh/g and 160 mAh/g, or between 140 mAh/g and 160 mAh/g, or between 140 mAh/g and 155 mAh/g, or between 145 mAh/g and 155 mAh/g, or between 160 mAh/g and 180 mAh/g, or between 180 mAh/g and 200 mAh/g, at room temperature when discharged from 4.3 V to 3.0 V.

In certain variations, the cathode materials provided herein may have a discharge capacity over an initial 5 cycles of at least 110 mAh/g, or at least 120 mAh/g, or at least 130 mAh/g, or at least 135 mAh/g, or at least 140 mAh/g, or at least 145 mAh/g, or at least 150 mAh/g, or between 110 mAh/g and 220 mAh/g, or between 120 mAh/g and 220 mAh/g, or between 120 mAh/g and 200 mAh/g, or between 120 mAh/g and 140 mAh/g, or between 130 mAh/g and 160 mAh/g, or between 140 mAh/g and 160 mAh/g, or between 140 mAh/g and 155 mAh/g, or between 145 mAh/g and 155 mAh/g, or between 160 mAh/g and 180 mAh/g, or between 180 mAh/g and 200 mAh/g, at room temperature when discharged from 4.3 V to 3.0 V at a rate of 0.5C. In some of the foregoing variations, the material may be activated in the first cycle through a charge to 4.3 V.

In some variations, the cathode materials provided herein may have a discharge capacity over an initial 100 cycles of at least 100 mAh/g, or at least 105 mAh/g, or at least 110 mAh/g, or at least 115 mAh/g, or at least 120 mAh/g, or at least 125 mAh/g, or at least 130 mAh/g, or at least 135 mAh/g, or at least 140 mAh/g, or at least 145 mAh/g, or at least 150 mAh/g, or between 110 mAh/g and 220 mAh/g, or between 120 mAh/g and 220 mAh/g, or between 120 mAh/g and 200 mAh/g, or between 120 mAh/g and 140 mAh/g, or between 130 mAh/g and 160 mAh/g, or between 140 mAh/g and 160 mAh/g, or between 140 mAh/g and 155 mAh/g, or between 145 mAh/g and 155 mAh/g, or between 160 mAh/g and 180 mAh/g, or between 180 mAh/g and 200 mAh/g, at room temperature when discharged from 4.3 V to 3.0 V

In certain variations, the cathode materials provided herein may have a discharge capacity over an initial 100 cycles of at least 100 mAh/g, or at least 105 mAh/g, or at least 110 mAh/g, or at least 115 mAh/g, or at least 120 mAh/g, or at least 125 mAh/g, or at least 130 mAh/g, or at least 135 mAh/g, or at least 140 mAh/g, or at least 145 mAh/g, or at least 150 mAh/g, or between 110 mAh/g and 220 mAh/g, or between 120 mAh/g and 220 mAh/g, or between 120 mAh/g and 200 mAh/g, or between 120 mAh/g and 140 mAh/g, or between 130 mAh/g and 160 mAh/g, or between 140 mAh/g and 160 mAh/g, or between 140 mAh/g and 155 mAh/g, or between 145 mAh/g and 155 mAh/g, or between 160 mAh/g and 180 mAh/g, or between 180 mAh/g and 200 mAh/g, at room temperature when discharged from 4.3 V to 3.0 V at a rate of 0.5C. In some of the foregoing variations, the material may be activated in the first cycle through a charge to 4.3 V.

In some variations, the cathode materials provided herein may have a discharge capacity over an initial 200 cycles of at least 130 mAh/g, or at least 135 mAh/g, or at least 140 mAh/g, or at least 145 mAh/g, or at least 150 mAh/g, or between 130 mAh/g and 160 mAh/g, or between 140 mAh/g and 155 mAh/g, or between 145 mAh/g and 155 mAh/g, at room temperature when discharged from 4.3 V to 3.0 V.

In certain variations, the cathode materials provided herein may have a discharge capacity over an initial 200 cycles of at least 130 mAh/g, or at least 135 mAh/g, or at least 140 mAh/g, or at least 145 mAh/g, or at least 150 mAh/g, or between 130 mAh/g and 160 mAh/g, or between 140 mAh/g and 155 mAh/g, or between 145 mAh/g and 155 mAh/g, at room temperature when discharged from 4.3 V to 3.0 V at a rate of 0.5C. In some of the foregoing variations, the material may be activated in the first cycle through a charge to 4.3 V.

In some variations, the cathode materials provided herein may have a discharge capacity over an initial 300 cycles of at least 130 mAh/g, or at least 135 mAh/g, or at least 140 mAh/g, or at least 145 mAh/g, or at least 150 mAh/g, or between 130 mAh/g and 160 mAh/g, or between 140 mAh/g and 155 mAh/g, or between 145 mAh/g and 155 mAh/g, at room temperature when discharged from 4.3 V to 3.0 V.

In certain variations, the cathode materials provided herein may have a discharge capacity over an initial 300 cycles of at least 130 mAh/g, or at least 135 mAh/g, or at least 140 mAh/g, or at least 145 mAh/g, or at least 150 mAh/g, or between 130 mAh/g and 160 mAh/g, or between 140 mAh/g and 155 mAh/g, or between 145 mAh/g and 155 mAh/g, at room temperature when discharged from 4.3 V to 3.0 V at a rate of 0.5C. In some of the foregoing variations, the material may be activated in the first cycle through a charge to 4.3 V.

In other variations, the cathode materials provided herein may have a discharge capacity over an initial 100 cycles of at least 90 mAh/g, or at least 95 mAh/g, or at least 100 mAh/g, or at least 105 mAh/g, or at least 110 mAh/g, or at least 115 mAh/g, or between 90 mAh/g and 125 mAh/g, or between 100 mAh/g and 125 mAh/g, or between 110 mAh/g and 125 mAh/g, or between 110 mAh/g and 120 mAh/g, at room temperature when discharged from 4.3 V to 3.0 V.

In certain variations, the cathode materials provided herein may have a discharge capacity over an initial 100 cycles of at least 90 mAh/g, or at least 95 mAh/g, or at least 100 mAh/g, or at least 105 mAh/g, or at least 110 mAh/g, or at least 115 mAh/g, or between 90 mAh/g and 125 mAh/g, or between 100 mAh/g and 125 mAh/g, or between 110 mAh/g and 125 mAh/g, or between 110 mAh/g and 120 mAh/g, at room temperature when discharged from 4.3 V to 3.0 V at a rate of 15C. In some of the foregoing variations, the material may be activated in the first cycle through a charge to 4.3 V.

In certain variations, the cathode materials provided herein may have a discharge capacity over an initial 100 cycles of at least 90 mAh/g, or at least 95 mAh/g, or at least 100 mAh/g, or at least 105 mAh/g, or at least 110 mAh/g, or at least 115 mAh/g, or between 90 mAh/g and 125 mAh/g, or between 100 mAh/g and 125 mAh/g, or between 110 mAh/g and 125 mAh/g, or between 110 mAh/g and 120 mAh/g, at room temperature when discharged from 4.3 V to 3.0 V at a rate of 20C. In some of the foregoing variations, the material may be activated in the first cycle through a charge to 4.3 V.

In yet other variations, the cathode materials provided herein may have a discharge capacity over an initial 100 cycles of at least 150 mAh/g, or at least 155 mAh/g, or at least 160 mAh/g, or between 150 mAh/g and 175 mAh/g, or between 155 mAh/g and 170 mAh/g, at room temperature when discharged from 4.5 V to 3.0 V.

In certain variations, the cathode materials provided herein may have a discharge capacity over an initial 100 cycles of at least 150 mAh/g, or at least 155 mAh/g, or at least 160 mAh/g, or between 150 mAh/g and 175 mAh/g, or between 155 mAh/g and 170 mAh/g, at room temperature when discharged from 4.5 V to 3.0 V at a rate of 5C. In some of the foregoing variations, the material may be activated in the first cycle through a charge to 4.5 V.

In certain variations, the cathode materials provided herein may have a discharge capacity over an initial 100 cycles of at least 150 mAh/g, or at least 155 mAh/g, or at least 160 mAh/g, or between 150 mAh/g and 175 mAh/g, or between 150 mAh/g and 170 mAh/g, or between 150 mAh/g and 165 mAh/g, at 328 K when discharged from 4.3 V to 3.0 V at a rate of 1C. In some of the foregoing variations, the material is activated in the first cycle through a charge to 4.3 V.

In yet other variations, the cathode materials provided herein may have a discharge capacity over an initial 100 cycles of at least 150 mAh/g, or at least 155 mAh/g, or at least 160 mAh/g, or between 150 mAh/g and 175 mAh/g, or between 150 mAh/g and 170 mAh/g, or between 150 mAh/g and 165 mAh/g, at 328 K when discharged from 4.3 V to 3.0 V at a rate of 5C. In some of the foregoing variations, the material is activated in the first cycle through a charge to 4.3 V.

In some variations, the cathode material has a discharge capacity over an initial 5 cycles of at least 130 mAh/g, or at least 135 mAh/g, or at least 140 mAh/g, or at least 145 mAh/g, or at least 150 mAh/g, or at least 155 mAh/g, or at least 160 mAh/g, or at least 165 mAh/g, or at least 170 mAh/g, or between 130 mAh/g and 230 mAh/g, between 130 mAh/g and 150 mAh/g, or between 130 mAh/g and 160 mAh/g, or between 130 mAh/g and 170 mAh/g, or between 140 mAh/g and 155 mAh/g, or between 145 mAh/g and 155 mAh/g, or between 150 mAh/g and 220 mAh/g, or between 170 mAh/g and 190 mAh/g, or between 190 mAh/g and 210 mAh/g, or between 210 mAh/g and 230 mAh/g, at room temperature when discharged from 4.5 V to 3.0 V.

In certain variations, the cathode material has a discharge capacity over an initial 5 cycles of at least 130 mAh/g, or at least 135 mAh/g, or at least 140 mAh/g, or at least 145 mAh/g, or at least 150 mAh/g, or at least 155 mAh/g, or at least 160 mAh/g, or at least 165 mAh/g, or at least 170 mAh/g, or between 130 mAh/g and 230 mAh/g, between 130 mAh/g and 150 mAh/g, or between 130 mAh/g and 160 mAh/g, or between 130 mAh/g and 170 mAh/g, or between 140 mAh/g and 155 mAh/g, or between 145 mAh/g and 155 mAh/g, or between 150 mAh/g and 220 mAh/g, or between 170 mAh/g and 190 mAh/g, or between 190 mAh/g and 210 mAh/g, or between 210 mAh/g and 230 mAh/g, at room temperature when discharged from 4.5 V to 3.0 V at a rate of 0.5C. In some of the foregoing variations, the material is activated in the first cycle through a charge to 4.5 V.

In certain variations, the cathode material has a discharge capacity over an initial 100 cycles of at least 110 mAh/g, or at least 115 mAh/g, or at least 120 mAh/g, or at least 125 mAh/g, or at least 130 mAh/g, or at least 135 mAh/g, or at least 140 mAh/g, or at least 145 mAh/g, or at least 150 mAh/g, or at least 155 mAh/g, or at least 160 mAh/g, or at least 165 mAh/g, or at least 170 mAh/g, or between 110 mAh/g and 230 mAh/g, or between 130 mAh/g and 230 mAh/g, between 130 mAh/g and 150 mAh/g, or between 130 mAh/g and 160 mAh/g, or between 130 mAh/g and 170 mAh/g, or between 140 mAh/g and 155 mAh/g, or between 145 mAh/g and 155 mAh/g, or between 170 mAh/g and 190 mAh/g, or between 190 mAh/g and 210 mAh/g, or between 210 mAh/g and 230 mAh/g, at room temperature when discharged from 4.5 V to 3.0 V.

In certain variations, the cathode material has a discharge capacity over an initial 100 cycles of at least 110 mAh/g, or at least 115 mAh/g, or at least 120 mAh/g, or at least 125 mAh/g, or at least 130 mAh/g, or at least 135 mAh/g, or at least 140 mAh/g, or at least 145 mAh/g, or at least 150 mAh/g, or at least 155 mAh/g, or at least 160 mAh/g, or at least 165 mAh/g, or at least 170 mAh/g, or between 110 mAh/g and 230 mAh/g, or between 130 mAh/g and 230 mAh/g, between 130 mAh/g and 150 mAh/g, or between 130 mAh/g and 160 mAh/g, or between 130 mAh/g and 170 mAh/g, or between 140 mAh/g and 155 mAh/g, or between 145 mAh/g and 155 mAh/g, or between 170 mAh/g and 190 mAh/g, or between 190 mAh/g and 210 mAh/g, or between 210 mAh/g and 230 mAh/g, at room temperature when discharged from 4.5 V to 3.0 V at a rate of 0.5C. In some of the foregoing variations, the material is activated in the first cycle through a charge to 4.5 V.

In certain variations, the cathode material may have any combination of the discharge capacities described above. The cathode material having any combination of the discharge capacities described above includes lithium metal oxide coated with a metal oxide shell prepared according to the mechanochemical processing methods described herein. In one variation, the cathode material having such discharge capacities described above has lithium cobalt oxide (LiCoO₂). In another variation that may be combined with the foregoing variation, the cathode material having such discharge capacities described above has lithium metal oxide coated with an aluminum oxide (alumina) shell.

### Decay Rate

As used herein, “decay rate” refers to the decrease in capacity as a function of given number of cycles. In some embodiments, the lithium metal oxide composites provided herein or produced according to any of the methods described herein has a decay rate at 1C of less than 0.5%, less than 0.25%, or less than 0.1% per cycle.

Retention Rate

As used herein, “retention rate” refers to the capacity retained after 50 cycles, calculated as Q/Qᵢₙᵢₜᵢₐₗ. In some embodiments, the lithium metal oxide composites provided herein or produced according to any of the methods described herein have an average retention rate after 50 cycles of at least 60%, at least 65%, at least 70%, at least 80%, at least 85%, at least 90%, or at least 95%.

Coulombic Efficiency

As used herein, “coulombic efficiency” refers to the ratio of discharging over charging capacity. A high coulombic efficiency is desired (e.g., at or near 100%), which would indicate that the amount of charge going in is equal or close to equal the amount of charge coming out. Further, consistency of coulombic efficiency over cycles is desired, which would allow for consumption of less electrolytes and power in, for example, a battery, and provide better prediction of when the battery is charged and discharged.

The lithium metal oxide composites provided herein or produced according to any of the methods described herein have a coulombic efficiency that is significantly better than materials known in the art. Such improved coulombic efficiency may be due to various factors, including for example, faster charge transportation and/or more stable solid electrolyte interface.

Such coulombic efficiency may, in certain embodiments, be achieved over at least 10 cycles, at least 20 cycles, at least 30 cycles, at least 40 cycles, or at least 50 cycles. In some embodiments, the lithium metal oxide composites provided herein or produced according to any of the methods described herein have an average coulombic efficiency of at least 60%, at least 70%, at least 80%, at least 85%, at least 90% or at least 95%. For example, in one embodiment, the lithium metal oxide composites have an average coulombic efficiency over about 50 cycles of at least 80%, at least 90%, or at least 95%.

### Batteries

The electrodes described herein may be used in a battery, including for example lithium-ion (Li-ion) batteries. Thus, in one aspect, provided is a Li-ion battery that includes: (i) an electrode, wherein the electrode includes a lithium metal oxide composite (or a plurality of such composites) provided herein or produced according to any of the methods described herein, and binder; and (ii) lithium ions.

In some embodiments, provided is a battery (e.g., a Li-ion battery) that includes: (i) a cathode, wherein the cathode includes a lithium metal oxide composite (or a plurality of such composites) provided herein or produced according to any of the methods described herein, and binder; and (ii) an anode. In an exemplary embodiment of the battery (e.g., a Li-ion battery), the cathode includes a LiCoO₂ composite coated with alumina dispersed within a carbon matrix, wherein such coating was formed from pyrolysis of MIL-53, provided herein or produced according to the methods described herein.

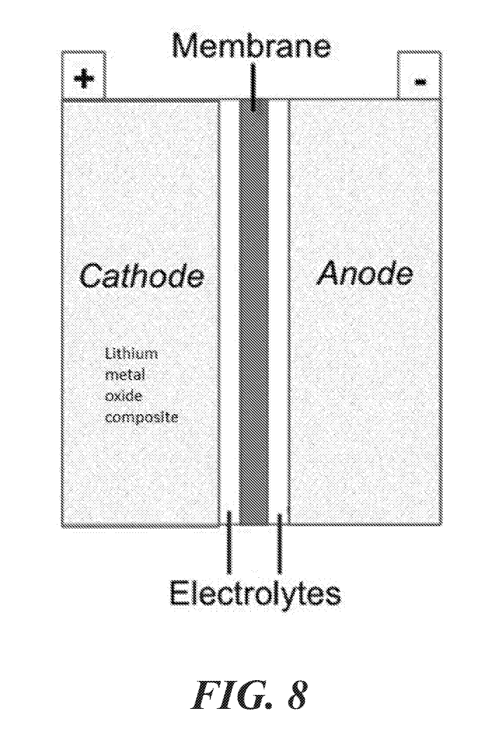

With reference to FIG. 8, an exemplary battery is depicted. In this exemplary battery, the cathode is made up a lithium metal oxide composite as described herein. It should be understood, however, that while the cathode is depicted as having the composites as described herein, in other exemplary batteries, the battery may include a cathode made up of a lithium metal oxide composite, and an anode without the lithium metal oxide composite; or the battery may include an anode and a cathode both made up of lithium metal oxide composites. It should also be understood that any of the lithium metal oxide composites as described herein may be used as electrode materials.

With reference again to FIG. 8, the exemplary battery may include any suitable membrane or other separator that separates the cathode and anode, while allowing ions to pass through. The electrodes and the membrane are submerged in an electrolyte. Any suitable electrolytes may be used in the battery. For example, in Li-ion batteries, the electrolytes may be bis-(trifluoromethanesulfonyl)imide lithium (LiTFSI), LiNO₃, and/or lithium hexafluorophosphate (LiPF₆) in solvents or solvent mixtures (e.g., organic solvent or solvent mixtures that may include carbonates, carboxylates, esters and/or ethers). When the battery charges, the ions (e.g., lithium ions in the case of a Li-ion battery) move through the electrolyte from the cathode to anode. During discharge, the ions move back to the cathode.

The batteries, including for example Li-ion batteries, described above may be suitable for use in portable wireless devices (e.g., cell phones) and electric vehicles. Other forms of batteries that may use the composites include, for example, metal-air batteries. The lithium metal oxide composites provided herein may also be suitable for use as the active electrode materials in fuel cells and super capacitors (e.g., pseudo-capacitors, hybrid capacitors, and Faradaic capacitors).

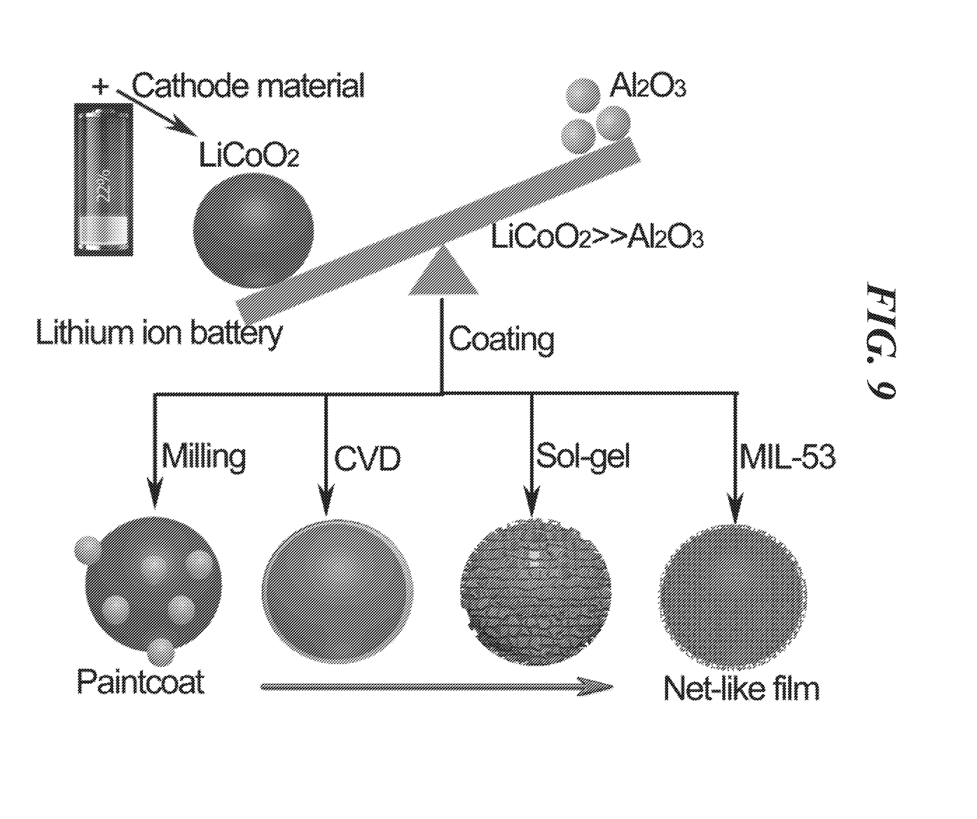

Coating lithium metal oxide with a metal oxide shell according to the methods described herein produce a material that has advantages over coating technologies currently employed in the art, such as milling, chemical vapor deposition (CVD) and Sol-gel. With reference to FIG. 9, milling typically yields a material in which metal oxide unevenly aggregates on the surface of the lithium metal oxide. The aggregation of the metal oxide can cause incomplete covering of the LiCoO₂ surface, and thus cause faster decay in electrochemical performance. With reference again to FIG. 9, CVD typically yields a material in which metal oxide forms a non-porous coating around lithium metal oxide. The lack of pores in the coating may lower the overall energy density of the electrode materials, and block the charge transportation during charge and discharge. With reference again to FIG. 9, Sol-gel typically yields a material in which metal oxide forms a cracked film over the lithium metal oxide. Such cracks in the film may hinder fast charge and ion diffusion.

In contrast, the methods described herein produce a material in which the metal oxide creates a net-like film over the lithium metal oxide, as depicted in FIG. 9. Such a net-like film is porous, and has dispersed metal centers that are interconnected and spaced based on the conductive carbon frameworks. The presence of such net-like films reduces the likelihood or prevents further aggregation when used. Such net-like film is created from the dispersion of metal oxide particles in a porous carbon matrix that surrounds the lithium metal oxide.

The incorporation of a lithium metal oxide coated with a net-like metal oxide film into the electrode material of a lithium ion battery yields various advantages compare to the coated lithium metal oxides prepared and used in the art. For example, the use of such lithium metal oxide coated with the net-like metal oxide films, produced according to the methods described herein, lead to: (a) faster kinetic and higher ion mobility; (b) improved utilization of all active species; and (c) longer cycle-life, as compared to the coated lithium metal oxides prepared by, for example, milling, chemical vapor deposition (CVD) and Sol-gel.

### ENUMERATED EMBODIMENTS

The following enumerated embodiments are representative of some aspects of the invention.

1. A lithium metal oxide composite, comprising:

lithium metal oxide coated with a metal oxide shell, wherein the metal oxide shell comprises a plurality of metal oxide particles dispersed in a porous carbon matrix.

2. The composite of embodiment 1, wherein the plurality of metal oxide particles are uniformly dispersed in the porous carbon matrix
3. The composite of embodiment 1 or 2, wherein the metal oxide particles are dispersed in the porous carbon matrix within a distance between about 0.5 nm to 5 nm apart.
4. The composite of any one of embodiments 1 to 3, wherein the lithium metal oxide comprises nickel, cobalt, manganese, or iron, or any combinations thereof.
5. The composite of any one of embodiments 1 to 3, wherein the lithium metal oxide comprises nickel, cobalt, or manganese, or any combinations thereof.
6. The composite of any one of embodiments 1 to 3, wherein the lithium metal oxide is LiNiₓCo_{y}Mn_{z}Oₐ, wherein:

x is 0 to 3;

y is 0 to 3;

z is 0 to 3; and

a is 0.1 to 10,

provided that at least one of x, y and z is greater than 0.
7. The composite of any one of embodiments 1 to 3, wherein the lithium metal oxide is LiCoO₂, LiMnO₂, LiMnO₃, LiMn₂O₄, LiNiO₂, LiNi_{0.5}Mn_{1.5}O₄, LiNiCoMnO₂, or LiNi_{0.6}Co_{0.2}Mn_{0.2}O₂, or any combinations thereof.
8. The composite of embodiment 7, wherein the lithium metal oxide is LiCoO₂, LiMnO₂. LiMnO₃, LiMn₂O₄, or LiNiO₂.
9. The composite of embodiment 7, wherein the lithium metal oxide is LiCoO₂.
10. The composite of embodiment 7, wherein the lithium metal oxide is LiNi_{0.5}Mn_{1.5}O₄.
11. The composite of embodiment 7, wherein the lithium metal oxide is LiNiCoMnO₂.
12. The composite of embodiment 7, wherein the lithium metal oxide is LiNi_{0.6}Co_{0.2}Mn_{0.2}O₂.
13. The composite of any one of embodiments 1 to 12, wherein the metal oxide particles comprise one or more metals selected from the group consisting of an early transition metal, aluminum or magnesium.
14. The composite of any one of embodiments 1 to 12, wherein the metal oxide particles comprise one or more metals selected from the group consisting of scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), and magnesium (Mg), or any combinations thereof.
15. The composite of any one of embodiments 1 to 12, wherein the metal oxide particles comprise aluminum (Al), zirconium (Zr), zinc (Zn), titanium (Ti), or any combinations thereof.
16. The composite of any one of embodiments 1 to 12, wherein the metal oxide particles are aluminum oxide particles, zirconium oxide particles, titanium oxide particles, or zinc oxide particles, or any combinations thereof.
17. The composite of any one of embodiments 1 to 16, wherein the porous carbon matrix is obtained by pyrolyzing a metal-organic framework shell coating the lithium metal oxide.
18. The composite of embodiment 17, wherein the metal-organic framework shell is an aluminum-based metal-organic framework shell, a zinc-based metal-organic framework shell, a zirconium-based metal-organic framework shell, or a magnesium-based metal-organic framework shell.
19. The composite of embodiment 17, wherein the metal-organic framework shell is a zeolitic imidazolate framework shell.
20. The composite of embodiment 17, wherein the metal-organic framework shell comprises NH₂-MIL-53, MIL-53, MOF-519, MOF-520, MOF-5, MOF-177, ZIF-8, ZIF-11, MOF-74, or any combinations thereof.
21. The composite of embodiment 20, wherein the metal-organic framework shell comprises MIL-53, MOF-519, MOF-520, MOF-5, MOF-177, ZIF-8, ZIF-11, MOF-74, or any combinations thereof.
22. The composite of embodiment 20, wherein the metal-organic framework shell comprises MIL-53.
23. The composite of embodiment 20, wherein the metal-organic framework shell comprises NH₂-MIL-53.
24. A method for producing a lithium metal oxide composite comprising lithium metal oxide coated with a metal oxide shell, the method comprising:

mechanochemically processing a metal-organic framework with lithium metal oxide to produce lithium metal oxide coated with a metal-organic framework shell; and

pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix.

25. The method of embodiment 24, wherein the method further comprises:

mechanochemically processing (i) one or more organic linking compounds, and (ii) one or more metal compounds to produce the metal-organic framework,
wherein the metal-organic framework comprises an open framework produced from the one or more organic linking compounds and the one or more metal compounds, wherein the open framework has one or more pores.
   26. A method for producing a lithium metal oxide composite comprising lithium metal oxide coated with a metal oxide shell, the method comprising:

mechanochemically processing (i) one or more organic linking compounds, (ii) one or more metal compounds; and (iii) lithium metal oxide to produce lithium metal oxide coated with a metal-organic framework shell; and

pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix.

27. The method of embodiment 25 or 26, wherein the one or more organic linking compounds are independently:

an aryl with at least one phenyl ring substituted with at least one —COOH moiety, or

a heteroaryl with at least pyridyl ring substituted with at least one —COOH moiety.

28. The method of embodiment 25 or 26, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.
29. The method of embodiment 25 or 26, wherein the one or more organic linking compounds are independently:

a monocyclic five-membered heteroaryl having at least two nitrogen atoms, wherein two of the nitrogen atoms are configured in the 1- and 3-positions of the monocyclic five-membered ring, or

a bicyclic ring system made up of at least one five-membered ring having at least two nitrogen atoms, wherein two of the nitrogen atoms are configured in the 1- and 3-positions of the five-membered ring.

30. The method of any one of embodiments 25 to 29, wherein the one or more metal compounds independently comprise scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), or magnesium (Mg) ions, or any combinations thereof.
31. The method of embodiment 25 or 26, wherein the metal-organic framework shell comprises NH₂-MIL-53, MIL-53, MOF-519, MOF-520, MOF-5, MOF-177, ZIF-8, ZIF-11, MOF-74, or any combinations thereof.
32. The method of embodiment 31, wherein the metal-organic framework shell comprises MIL-53, MOF-519, MOF-520, MOF-5, MOF-177, ZIF-8, ZIF-11, MOF-74, or any combinations thereof.
33. The method of embodiment 31, wherein the metal-organic framework shell comprises MIL-53.
34. The method of embodiment 31, wherein the metal-organic framework shell comprises NH₂-MIL-53.
35. The method of embodiment 25 or 26, wherein the metal-organic framework shell comprises an aluminum-based metal-organic framework.
36. The method of any one of embodiments 24 to 35, wherein the lithium metal oxide is LiCoO₂, LiMnO₂, LiMnO₃, LiMn₂O₄, LiNiO₂, LiNi_{0.5}Mn_{1.5}O₄, LiNiCoMnO₂, or LiNi_{0.6}Co_{0.2}Mn_{0.2}O₂, or any combinations thereof.
37. The method of embodiment 36, wherein the lithium metal oxide is LiCoO₂, LiMnO₂, LiMnO₃, LiMn₂O₄, or LiNiO₂.
38. The method of embodiment 36, wherein the lithium metal oxide is LiCoO₂.
39. The method of embodiment 36, wherein the lithium metal oxide is LiNi_{0.5}Mn_{1.5}O₄.
40. The method of embodiment 36, wherein the lithium metal oxide is LiNiCoMnO₂.
41. The method of embodiment 36, wherein the lithium metal oxide is LiNi_{0.6}Co_{0.2}Mn_{0.2}O₂.
42. A lithium metal oxide composite produced according to any one of embodiments 24 to 41.
43. An electrode, comprising:

a lithium metal oxide composite according to any one of embodiments 1 to 23 and 42; and

binder.

44. The electrode of embodiment 43, wherein the electrode is a cathode.
45. A battery, comprising:

an cathode of embodiment 44; and

lithium ions.

46. A cathode material for a lithium ion battery, comprising:

lithium metal oxide coated with a metal oxide shell, wherein the metal oxide shell comprises a plurality of metal oxide particles dispersed in a porous carbon matrix.

47. The cathode material of embodiment 46, wherein the plurality of metal oxide particles are uniformly dispersed in the porous carbon matrix.
48. The cathode material of embodiment 46 or 47, wherein the cathode material has a discharge capacity:

(i) over an initial 100 cycles of at least 130 mAh/g at room temperature when discharged from 4.3 V to 3.0 V; or

(ii) over an initial 200 cycles of at least 130 mAh/g at room temperature when discharged from 4.3 V to 3.0 V; or

(iii) over an initial 300 cycles of at least 130 mAh/g at room temperature when discharged from 4.3 V to 3.0 V; or

(iv) over an initial 100 cycles of at least 90 mAh/g at room temperature when discharged from 4.3 V to 3.0 V; or

(v) over an initial 100 cycles of at least 90 mAh/g at room temperature when discharged from 4.3 V to 3.0 V; or

(vi) over an initial 100 cycles of at least 150 mAh/g at room temperature when discharged from 4.5 V to 3.0 V; or

(vii) over an initial 100 cycles of at least 150 mAh/g at 328 K when discharged from 4.3 V to 3.0 V; or

(viii) over an initial 100 cycles of at least at least 150 mAh/g at 328 K when discharged from 4.3 V to 3.0 V; or

(ix) over an initial 5 cycles of at least 130 mAh/g at room temperature when discharged from 4.5 V to 3.0 V; or

(x) over an initial 100 cycles of at least 110 mAh/g at room temperature when discharged from 4.5 V to 3.0 V; or

any combinations of (i)-(x) above.

49. The cathode material of embodiment 46 or 47, wherein the cathode material has a discharge capacity:

(i) over an initial 100 cycles of at least 130 mAh/g at room temperature when discharged from 4.3 V to 3.0 V at 0.5C; or

(ii) over an initial 200 cycles of at least 130 mAh/g at room temperature when discharged from 4.3 V to 3.0 V at 0.5C; or

(iii) over an initial 300 cycles of at least 130 mAh/g at room temperature when discharged from 4.3 V to 3.0 V at 0.5C; or

(iv) over an initial 100 cycles of at least 90 mAh/g at room temperature when discharged from 4.3 V to 3.0 V at 15C; or

(v) over an initial 100 cycles of at least 90 mAh/g at room temperature when discharged from 4.3 V to 3.0 V at 20C; or

(vi) over an initial 100 cycles of at least 150 mAh/g at room temperature when discharged from 4.5 V to 3.0 V at 5C; or

(vii) over an initial 100 cycles of at least 150 mAh/g at 328 K when discharged from 4.3 V to 3.0 V at 1C; or

(viii) over an initial 100 cycles of at least at least 150 mAh/g at 328 K when discharged from 4.3 V to 3.0 V at 5C; or

(ix) over an initial 5 cycles of at least 130 mAh/g at room temperature when discharged from 4.5 V to 3.0 V at 0.5C; or

(x) over an initial 100 cycles of at least 110 mAh/g at room temperature when discharged from 4.5 V to 3.0 V at 0.5C; or

any combinations of (i)-(x) above.

50. The cathode material of embodiment 46 or 47, wherein the cathode material has a discharge capacity:

(i) over an initial 100 cycles of at least 130 mAh/g at room temperature when discharged from 4.3 V to 3.0 V after the material is activated in the first cycle through a charge to 4.3 V at 0.5C; or

(ii) over an initial 200 cycles of at least 130 mAh/g at room temperature when discharged from 4.3 V to 3.0 V after the material is activated in the first cycle through a charge to 4.3 V at 0.5C; or

(iii) over an initial 300 cycles of at least 130 mAh/g at room temperature when discharged from 4.3 V to 3.0 V after the material is activated in the first cycle through a charge to 4.3 V at 0.5C; or

(iv) over an initial 100 cycles of at least 90 mAh/g at room temperature when discharged from 4.3 V to 3.0 V after the material is activated in the first cycle through a charge to 4.3 V at 15C; or

(v) over an initial 100 cycles of at least 90 mAh/g at room temperature when discharged from 4.3 V to 3.0 V after the material is activated in the first cycle through a charge to 4.3 V at 20C; or

(vi) over an initial 100 cycles of at least 150 mAh/g at room temperature when discharged from 4.5 V to 3.0 V after the material is activated in the first cycle through a charge to 4.5 V at 5C; or

(vii) over an initial 100 cycles of at least 150 mAh/g at 328 K when discharged from 4.3 V to 3.0 V after the material is activated in the first cycle through a charge to 4.3 V at 1C; or

(viii) over an initial 100 cycles of at least at least 150 mAh/g at 328 K when discharged from 4.3 V to 3.0 V after the material is activated in the first cycle through a charge to 4.3 V at 5C; or

(ix) over an initial 5 cycles of at least 130 mAh/g at room temperature when discharged from 4.5 V to 3.0 V after the material is activated in the first cycle through a charge to 4.5 V at 0.5C; or

(x) over an initial 100 cycles of at least 110 mAh/g at room temperature when discharged from 4.5 V to 3.0 V after the material is activated in the first cycle through a charge to 4.5 V at 0.5C; or

any combinations of (i)-(x) above.

51. The cathode material of any one of embodiments 46 to 50, wherein the lithium metal oxide coated with a metal oxide shell is obtained by a method comprising:

mechanochemically processing (i) one or more organic linking compounds, (ii) one or more metal compounds; and (iii) lithium metal oxide to produce lithium metal oxide coated with a metal-organic framework shell; and

pyrolyzing the lithium metal oxide coated with the metal-organic framework shell to produce the lithium metal oxide coated with a metal oxide shell.

52. The cathode material of embodiment 51, wherein the one or more organic linking compounds are independently:

an aryl with at least one phenyl ring substituted with at least one —COOH moiety, or

a heteroaryl with at least pyridyl ring substituted with at least one —COOH moiety.

53. The cathode material of embodiment 51, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.
54. The cathode material of embodiment 51, wherein the one or more organic linking compounds are independently:

a monocyclic five-membered heteroaryl having at least two nitrogen atoms, wherein two of the nitrogen atoms are configured in the 1- and 3-positions of the monocyclic five-membered ring, or

a bicyclic ring system made up of at least one five-membered ring having at least two nitrogen atoms, wherein two of the nitrogen atoms are configured in the 1- and 3-positions of the five-membered ring.

55. The cathode material of embodiment 51, wherein the one or more metal compounds independently comprise scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), or magnesium (Mg) ions, or any combinations thereof
56. The cathode material of embodiment 51, wherein the metal-organic framework shell comprises NH₂-MIL-53, MIL-53, MOF-519, MOF-520, MOF-5, MOF-177, ZIF-8, ZIF-11, MOF-74, or any combinations thereof.
57. The cathode material of embodiment 56, wherein the metal-organic framework shell comprises MIL-53, MOF-519, MOF-520, MOF-5, MOF-177, ZIF-8, ZIF-11, MOF-74, or any combinations thereof.
58. The cathode material of embodiment 56, wherein the metal-organic framework shell comprises MIL-53.
59. The cathode material of embodiment 56, wherein the metal-organic framework shell comprises NH₂-MIL-53.
60. The cathode material of embodiment 51, wherein the metal-organic framework is an aluminum-based metal-organic framework.
61. The cathode material of any one of embodiments 46 to 50, wherein the lithium metal oxide is LiCoO₂, LiMnO₂, LiMnO₃, LiMn₂O₄, LiNiO₂, LiNi_{0.5}Mn_{1.5}O₄, LiNiCoMnO₂, or LiNi_{0.6}Co_{0.2}Mn_{0.2}O₂, or any combinations thereof.
62. The cathode material of embodiment 61, wherein the lithium metal oxide is LiCoO₂. LiMnO₂, LiMnO₃, LiMn₂O₄, or LiNiO₂.
63. The cathode material of embodiment 61, wherein the lithium metal oxide is LiCoO₂.
64. The cathode material of embodiment 61, wherein the lithium metal oxide is LiNi_{0.5}Mn_{1.5}O₄.
65. The cathode material of embodiment 61, wherein the lithium metal oxide is LiNiCoMnO₂.
66. The cathode material of embodiment 61, wherein the lithium metal oxide is LiNi_{0.6}Co_{0.2}Mn_{0.2}O₂.
67. The cathode material of any one of embodiments 46 to 66, wherein the metal oxide particles are aluminum oxide (alumina) particles.
68. A lithium ion battery comprising:

a cathode comprising the cathode material of any one of embodiments 46 to 67;

an anode; and

a separator between the cathode and anode.

### EXAMPLES

The following Examples are merely illustrative and are not meant to limit any aspects of the present disclosure in any way.

### Example 1

### Synthesis, Characterization and Use of LiCoO₂ Coated with MIL-53

This Example demonstrates the synthesis of LiCoO₂ coated with MIL-53 (MIL-53@LiCoO₂), and the pyrolysis of MIL-53@LiCoO₂ to produce LiCoO₂ coated with alumina particles uniformly dispersed in a porous carbon matrix.

Synthesis of MIL-53:

The synthesis of MIL-53 (an aluminum-MOF) was carried out under mild hydrothermal conditions using aluminum nitrate nonahydrate (Al(NO₃)₃.9H₂O, 1.300 g), 1,4-benzenedicarboxylic acid (C₆H₄-1,4-(CO₂H)₂ or BDC, 0.288 g), and deionized water (80 mL). The reaction was performed in a 100 mL Teflon-lined stainless steel Parr bomb under autogenous pressure for 72 hours at 220° C.

Synthesis of MIL-53@LiCoO₂:

MIL-53@LiCoO₂ was synthesized through a simple mechanochemical synthetic protocol. Reactions were carried out in a ball mill (QM-3B, Nanjing University Instrument Factory, China) using a 80 mL polytetrafluoroethylene (PTFE) grinding jar with five 10 mm zirconia balls. A solid mixture of LiCoO₂ (1.00 g) and MIL-53 (0.110 g) was placed into the jar and ground at high speed for 30 mins.

Pyrolysis:

MIL-53@LiCoO₂ prepared according to the procedure above was transferred to a tube furnace, and heated at 600° C. for 5 h under air with both heating rate and cooling rate of 5° C. min⁻¹.

Characterization:

Powder X-ray diffraction (PXRD) pattern was analyzed with monochromatized Cu-Kα (λ=1.54178 Å) incident radiation by a D8 Advance Bruker powder diffractometer operating at 40 kV voltage and 50 mA current. ICP (Inductive Coupled Plasma Emission Spectrometer) was tested by Varian 725 inductively coupled plasma emission spectrometer. Scanning electron microscopy (SEM and EDX; JSM7000 instrument, JEOL). X-ray photoelectron spectroscopy (XPS) was performed on the Thermo Scientific ESCALab 250Xi using 200 W monochromated Al Kα radiation. The 500 μm X-ray spot was used for XPS analysis.

Cathode Preparation:

86 wt % pyrolyzed MIL-53@LiCoO₂ (as the active material), 8 wt % Super P carbon black and 6 wt % poly(vinylidene fluoride) (PVDF) binder were mixed in N-methyl pyrrolidinone (NMP) solution to form a slurry. The slurry was cast onto aluminum foil and dried under a vacuum at 120° C. for 12 h. Coin cells of CR2032 type were constructed inside an argon-filled glove box using a lithium metal foil as the negative electrode and the composite positive electrode separated by polypropylene microporous separator (Celgard 2400). The electrolyte used was 1 M LiPF₆ in ethyl carbonate (EC), diethyl carbonate (DMC) and ethyl methyl carbonate (1:1:1 v/v/v). Assembled coin cells were allowed to soak overnight and then were charged and discharged galvanostatically between 3.0 V and 4.3 V with a LAND CT2001A instrument (Wuhan, China) at ambient temperature.

Electrochemical Tests:

The cyclic voltammetry of the active material was recorded with an electrochemical workstation (CHI 760E: CH Instrumental Inc.). The range of voltage was between 3.0 V and 4.3 V with a scan rate of 0.1 mV s⁻¹. The electrochemical impedance spectra were also performed using an electrochemical workstation (CHI 760E: CH Instrumental Inc.) with the frequency range of 104 Hz to 10⁻¹ Hz with an applied voltage of 0.25 V after 4 cycles at 50 mA g⁻¹. All the tests were carried out at room temperature.

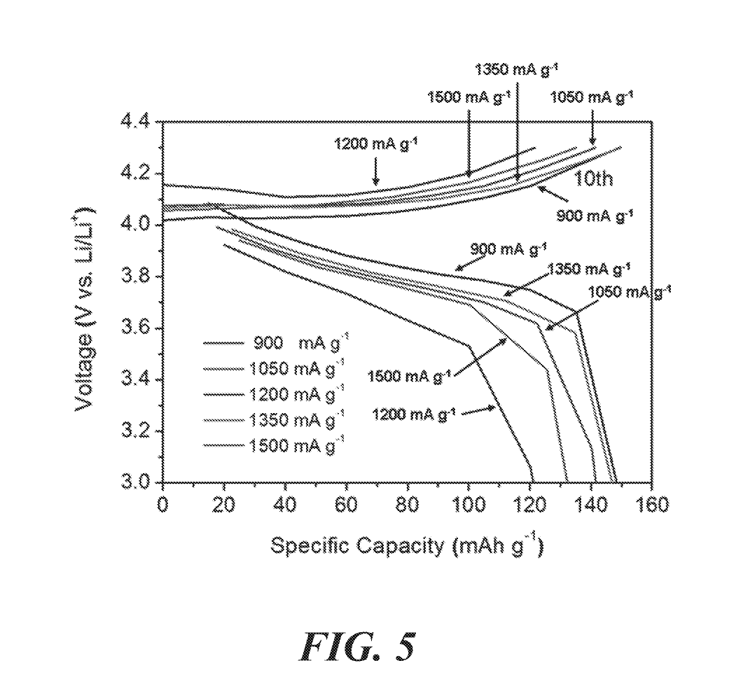

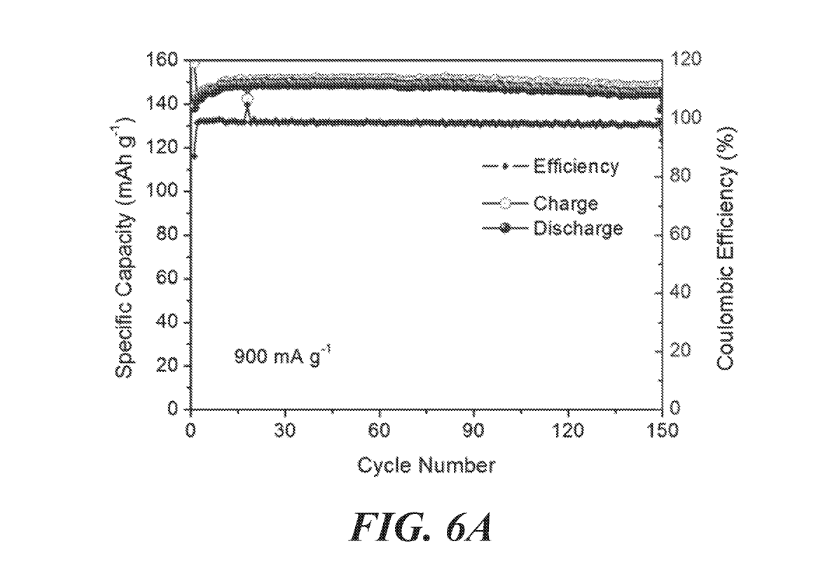

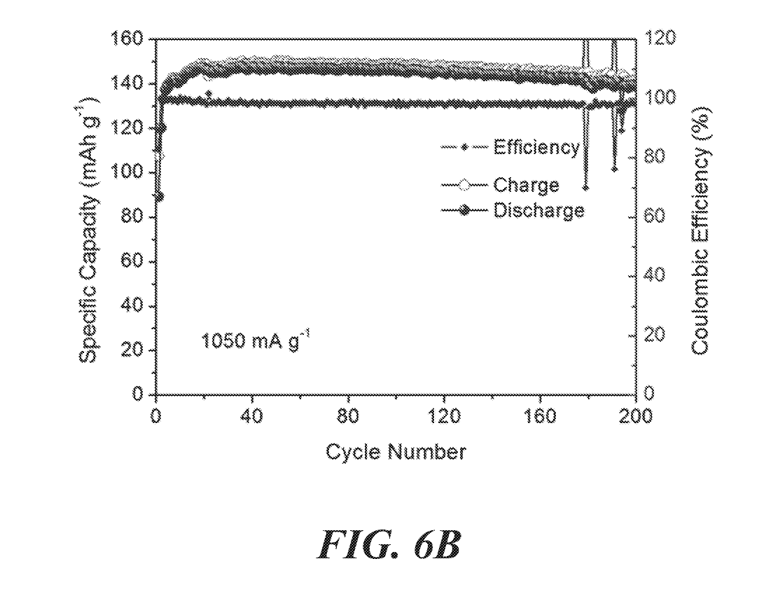

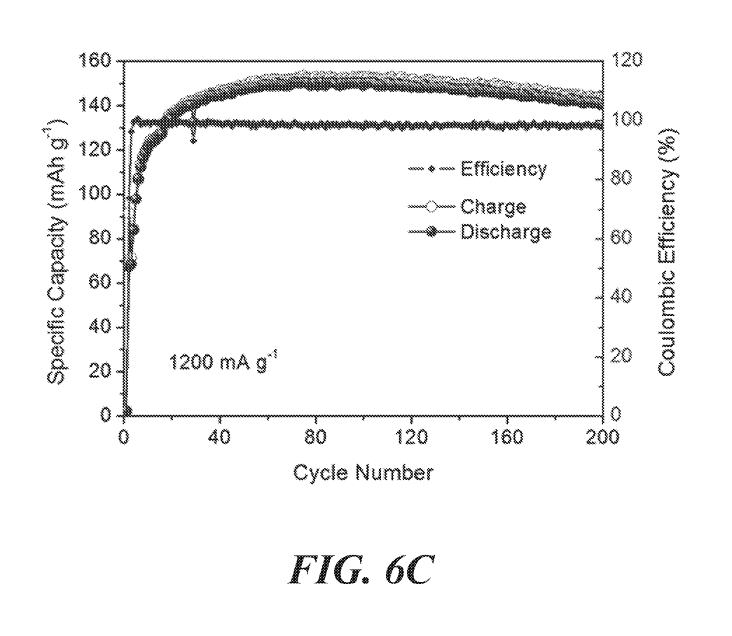

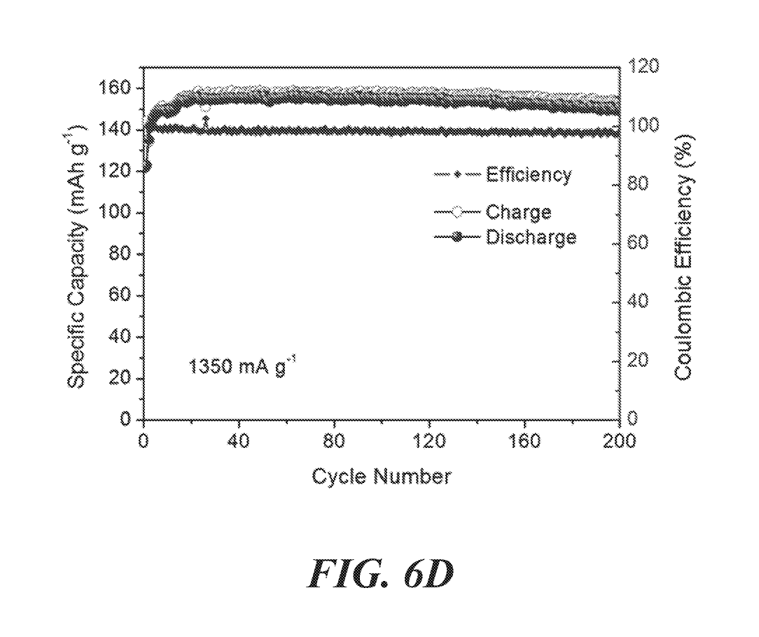

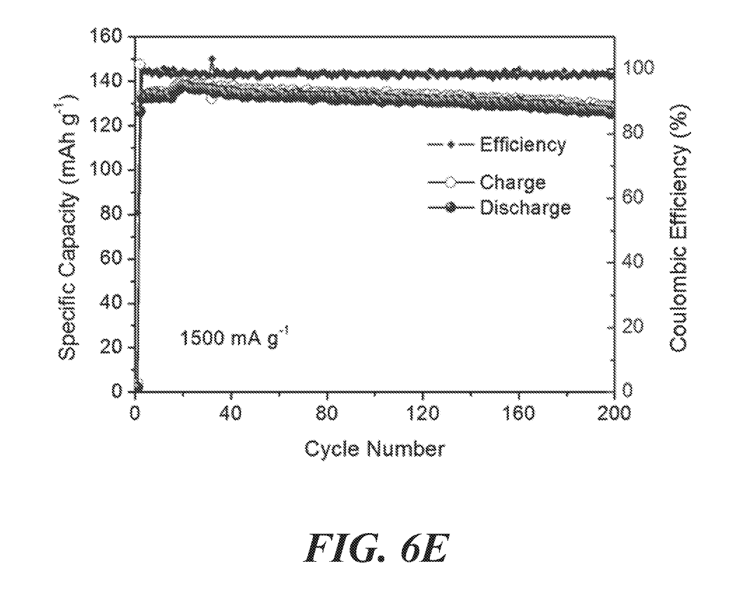

The results from the electrochemical tests are provided in FIGS. 5 and 6A-6E. FIG. 5 shows charge/discharge voltage vs. capacity profiles of the MIL-53 coated LiCoO₂ cathode at various charge/discharge rates. FIGS. 6A-6E show the charge/discharge capacity over cycles along with the Columbic efficiency at various charge/discharge rates.

### Comparative Example A

This Example compares the electrochemical performance of: (A) pyrolyzed MIL-53@LiCoO₂ (Material A); (B) LiCoO₂ coated with alumina by mixing alumina and LiCoO₂ and pyrolyzed (Material B); and (C) LiCoO₂ without any coating (Material C).

Synthesis of Material A:

Material A was prepared according to the procedure in Example 1.

Synthesis of Material B:

Material B was synthesized in a ball mill (QM-3B, Nanjing University Instrument Factory, China) using a 80 mL PTFE grinding jar with five 10 mm zirconia balls. A solid mixture of LiCoO₂ (1.00 g) and Al2O3 (0.120 g) was placed into the jar and ground at high speed for 30 mins.

Synthesis of Material C:

Material C was LiCoO₂ purchased from Sigma-Aldrich.

Pyrolysis:

Materials A, B and C prepared according to the procedure above were each transferred to separate tube furnaces, and heated at 600° C. for 5 h under air with both heating and cooling rates of 5° C. min⁻¹.

Characterization:

Powder X-ray diffraction (PXRD) pattern was analyzed with monochromatized Cu-Kα (λ=1.54178 Å) incident radiation by a D8 Advance Bruker powder diffractometer operating at 40 kV voltage and 50 mA current. ICP (Inductive Coupled Plasma Emission Spectrometer) was tested by Varian 725 inductively coupled plasma emission spectrometer. Scanning electron microscopy (SEM and EDX; JSM7000 instrument, JEOL). X-ray photoelectron spectroscopy (XPS) was performed on the Thermo Scientific ESCALab 250Xi using 200 W monochromated Al Kα radiation. The 500 μm X-ray spot was used for XPS analysis.

Cathode Preparation:

Three separate cathodes were prepared using Materials A, B and C, respectively, as the active material. 86 wt % of the active material, 8 wt % Super P carbon black and 6 wt % poly(vinylidene fluoride) (PVDF) binder were mixed in N-methyl pyrrolidinone (NMP) solution to form a slurry. The slurry was cast onto aluminum foil and dried under a vacuum at 120° C. for 12 h. Coin cells of CR2032 type were constructed inside an argon-filled glove box using a lithium metal foil as the negative electrode and the composite positive electrode separated by polypropylene microporous separator (Celgard 2400). The electrolyte used was 1 M LiPF₆ in ethyl carbonate (EC), diethyl carbonate (DMC) and ethyl methyl carbonate (1:1:1 v/v/v). Assembled coin cells were allowed to soak overnight and then were charged and discharged galvanostatically between 3.0 V and 4.3 V with a LAND CT2001A instrument (Wuhan, China) at ambient temperature.

Electrochemical Tests:

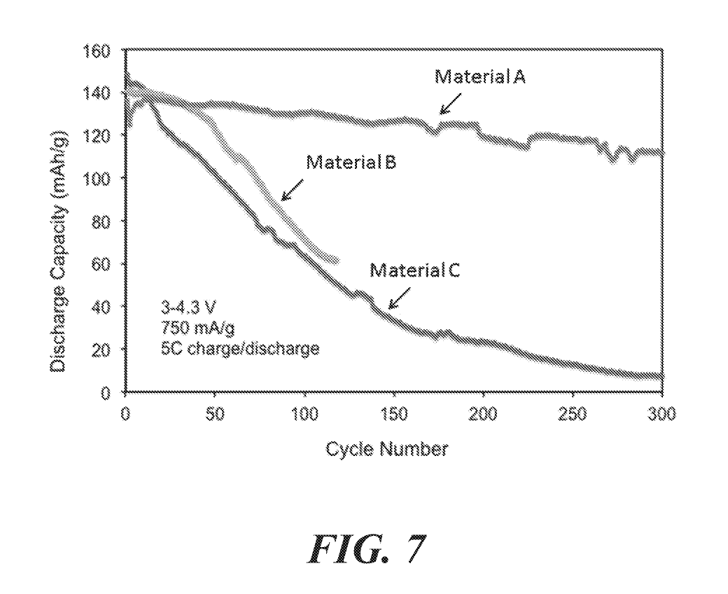

For each of Materials A, B and C, the cyclic voltammetry of the active material was recorded with an electrochemical workstation (CHI 760E: CH Instrumental Inc.). The range of voltage was between 3.0 V and 4.3 V with a scan rate of 0.1 mV s⁻¹. The electrochemical impedance were also measured using an electrochemical workstation (CHI 760E: CH Instrumental Inc.) with the frequency range of 104 Hz to 10⁻¹ Hz with an applied voltage of 0.25 V after 4 cycles at 50 mA g⁻¹. All the tests were carried out at room temperature. The results of these electrochemical tests are summarized in FIG. 7.

With reference to FIG. 7, Material B showed improved electrochemical performance as the cathode material when compared to Material C; however, decay was also observed for Material B over 50+ cycles. In contract, Material A was observed to be very stable over hundreds of cycles, even at a charge/discharge rate of 5C.

### Example 2

### Characterization and Use of LiCoO₂ Coated with MIL-53

This Example demonstrates further characterization of LiCoO₂ coated with MIL-53, before and after pyrolysis.

Synthesis:

MIL-53@LiCoO₂ and pyrolyzed MIL-53@LiCoO₂ were prepared according to the procedures set forth in Example 1 above. It should be understood that when MIL-53@LiCoO₂ is pyrolyzed by heating the sample at 600° C. for 5 hours under air, the resulting pyrolyzed material is also referred to as “MIL-53 @LiCoO₂-600-Air”.

Al₂O₃ powder@LiCoO₂ was used for comparison in the characterization and electrochemical studies described below. The Al₂O₃ powder@LiCoO₂ was prepared by mixing Al₂O₃ with LiCoO₂, ball-milling for 12 hours, and then pyrolyzing by heating the sample at 600° C. for 5 hours under air. The resulting pyrolyzed material is also referred to as “Al₂O₃ powder@ LiCoO₂-600-Air”.

Aluminum isopropoxide@LiCoO₂ was also used for comparison in the electrochemical studies described below. The aluminum isopropoxide@LiCoO₂ was prepared by mixing aluminum isopropoxide with LiCoO₂, ball-milling for 12 hours, and then pyrolyzing by heating the sample at 600° C. for 5 hours under air. The resulting pyrolyzed material is also referred to as “Aluminum isopropoxide@LiCoO₂-600-Air”.

Pure LiCoO₂ was also used for comparison in the electrochemical studies described below, and was obtained from a commercially available source. It should generally be understood that “pure LiCoO₂” refers to LiCoO₂ that has not been coated with a MOF.

Characterization:

The MIL-53@LiCoO₂ and pyrolyzed MIL-53@LiCoO₂ prepared in this Example was characterized using various techniques, including scanning electron microscopy (SEM) and elemental mapping by energy-dispersive X-ray spectroscopy (EDS).

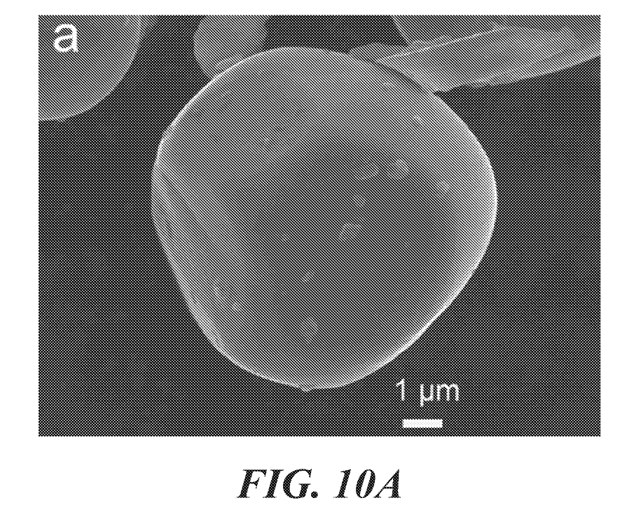

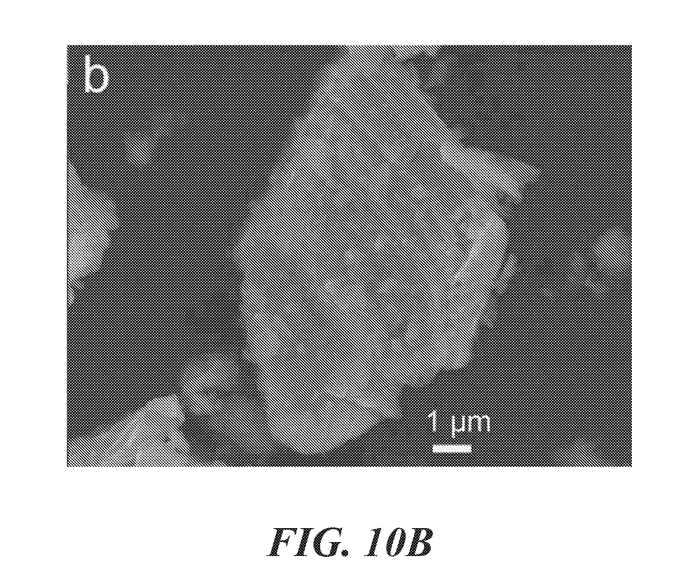

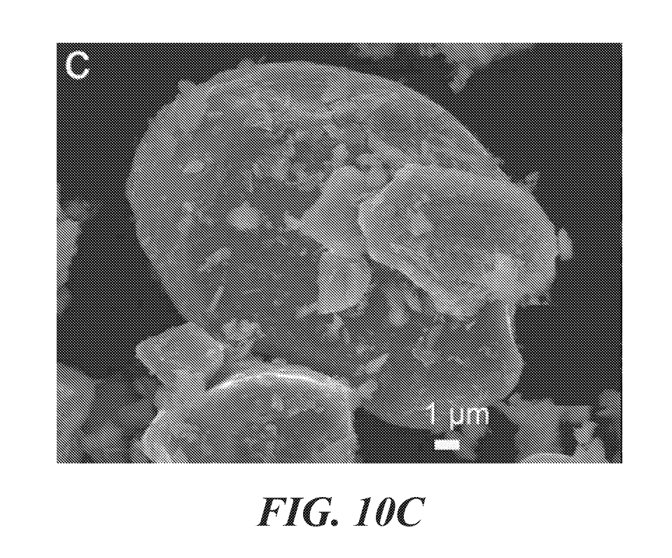

SEM was performed using a JSM7000 instrument (JEOL). The SEM images for pure LiCoO₂, MIL-53@LiCoO₂, and MIL-53@LiCoO₂-600-Air are shown in FIGS. 10A-10C, respectively.

Elemental mapping of MIL-53@LiCoO₂-600-Air (FIG. 11A) and Al₂O₃ powder@LiCoO₂-600-Air (FIG. 11B) for cobalt, aluminum and oxygen was performed by energy-dispersive X-ray spectroscopy (EDS). With reference to FIG. 11A, the image in the top, left quadrant depicts an exemplary MIL-53@LiCoO₂-600-Air composite. The image in the top, right quadrant labeled “Co-K” of FIG. 11A depicts the presence of cobalt from the LiCoO₂. The image in the bottom, right quadrant labeled “O-K” of FIG. 11A depicts the presence of oxygen from the LiCoO₂ and alumina. The image in the bottom, left quadrant labeled “Al-K” of FIG. 11A depicts the presence of aluminum from the MIL-53. This image shows that aluminum from the MIL-53 was present in the entire composite, since the areas in which aluminum was present corresponded to the shape of the composite as seen in the image of the top, left quadrant. Thus, the elemental mapping of MIL-53@LiCoO₂-600-Air in the images of FIG. 11A reveals the structure of a carbonized composite in which aluminum is evenly dispersed around LiCoO₂.

With reference to FIG. 11B, the image in the top, left quadrant depicts an exemplary Al₂O₃ powder@LiCoO₂-600-Air composite. The image in the top, right quadrant labeled “Co-K” of FIG. 11B depicts the presence of cobalt from the LiCoO₂. The image in the bottom, right quadrant labeled “O-K” of FIG. 11B depicts the presence of oxygen from the LiCoO₂ and alumina. The image in the bottom, left quadrant labeled “Al-K” of FIG. 11B depicts the presence of aluminum from the Al₂O₃. This image shows that aluminum from the Al₂O₃ was present in only a portion of the composite, since the areas in which aluminum was present did not entirely correspond to the shape of the composite as seen in the image of the top, left quadrant. Thus, the elemental mapping of Al₂O₃ powder@LiCoO₂-600-Air in the images of FIG. 11B reveals the structure of a carbonized composite in which aluminum is incompletely dispersed around LiCoO₂.

Electrochemical Tests:

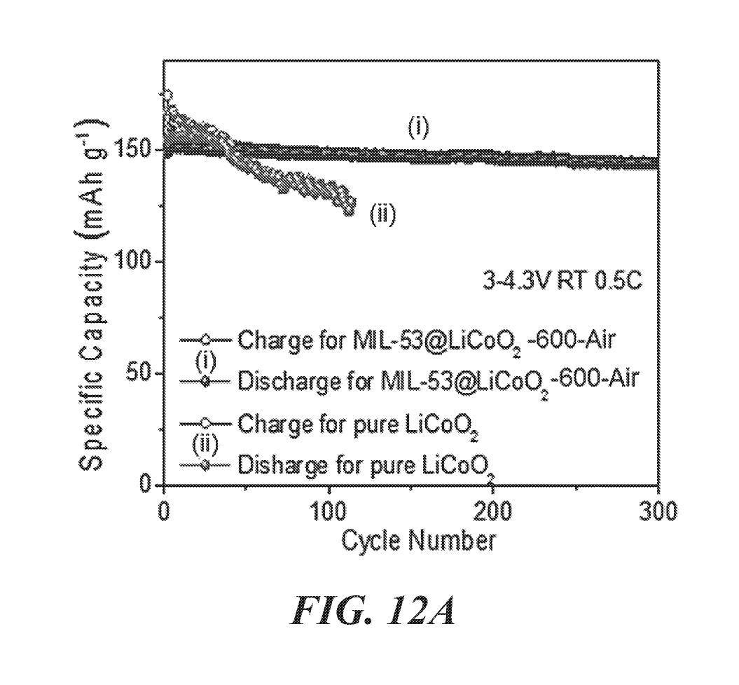

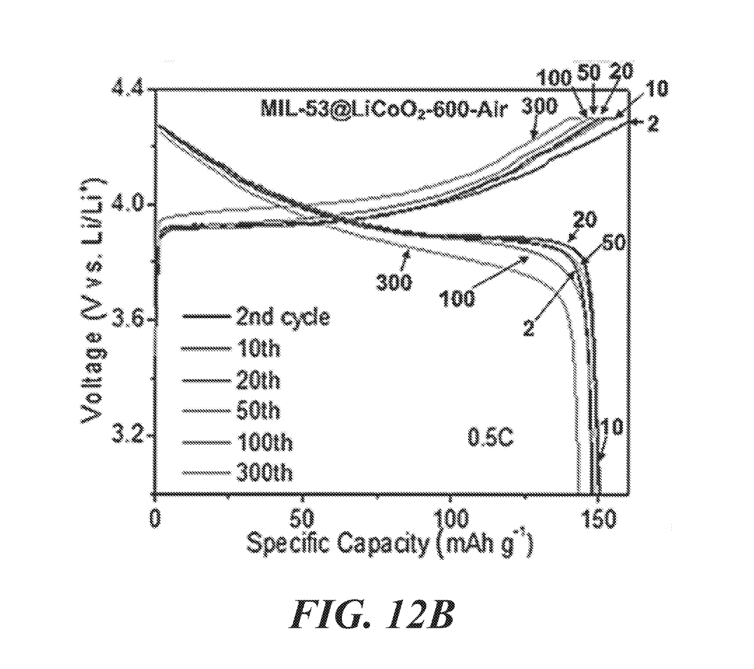

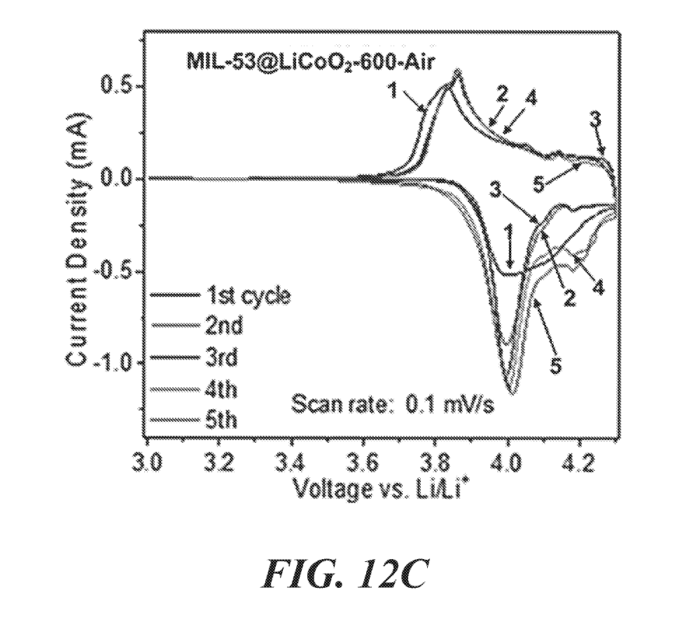

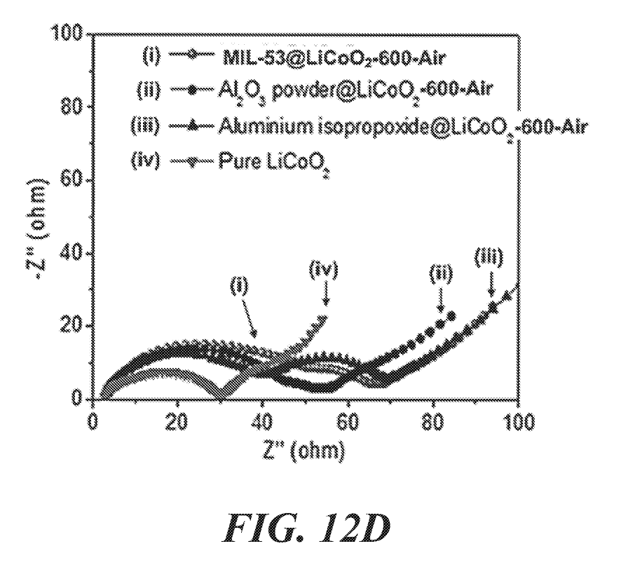

Various electrochemical tests were performed for MIL-53@LiCoO₂-600-Air, as well as for Al₂O₃ powder@LiCoO₂, aluminum isopropoxide@LiCoO₂, and pure LiCoO₂ as a comparison. Cathode were prepared according to the procedure set forth in Example 1 above. The cycle-life performance, the voltage profile, cyclic voltammetry and electrochemical impedance were measured according to the procedures set forth in Example 1 above. See FIGS. 12A-12D, 13A-13D, 14A-14F, 15 and 16A-16B.

The results from these electrochemical tests in this Example demonstrated that the use of MIL-53 @LiCoO₂-600-Air achieved greater stability and longer cycle-life, and was suitable for use at higher voltages and temperatures when compared to the use of Al₂O₃ powder@LiCoO₂-600-Air, aluminum isopropoxide@LiCoO₂-600-Air, and pure LiCoO₂.

With reference to FIG. 12A, cycle-life performance of pure LiCoO₂ and MIL-42@LiCoO₂-600-Air was performed between 3.0 and 4.3V at a rate of 0.5C. MIL-53 @ LiCoO₂-600-Air was observed to have greater stability and longer cycle-life as compared to pure LiCoO₂.

With reference to FIG. 12B, the voltage profile of MIL-52@LiCoO₂-600-Air was obtained at a rate of 0.5C.

With reference to FIG. 12C, cyclic voltammograms of MIL-52@LiCoO₂-600-Air were obtained at a scan rate of 0.1 mV/s between 3.0 and 4.3V, wherein the initial point corresponded to the open-circuit voltage of the cell.

With reference to FIG. 12D, Nyquist plots were obtained for MIL-52@LiCoO₂-600-Air. Al₂O₃ powder@LiCoO₂-600-Air, aluminum isopropoxide@LiCoO₂-600-Air and pure LiCoO₂ after four cycles.

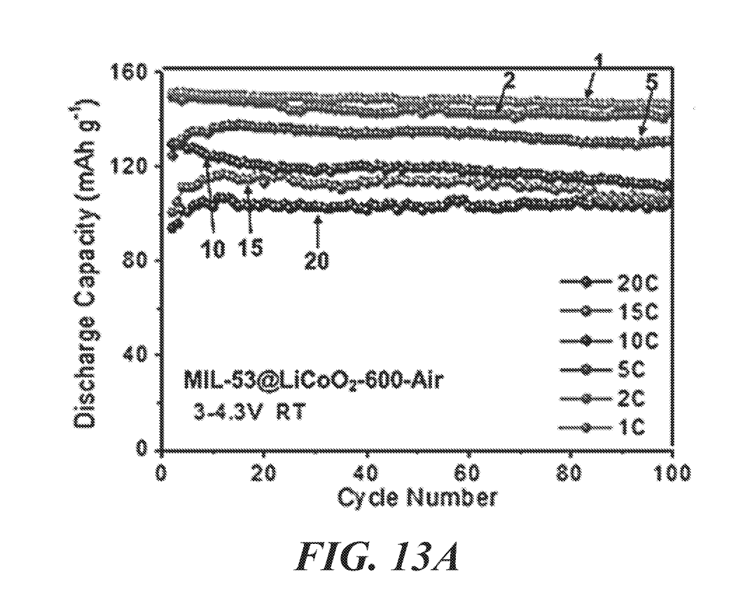

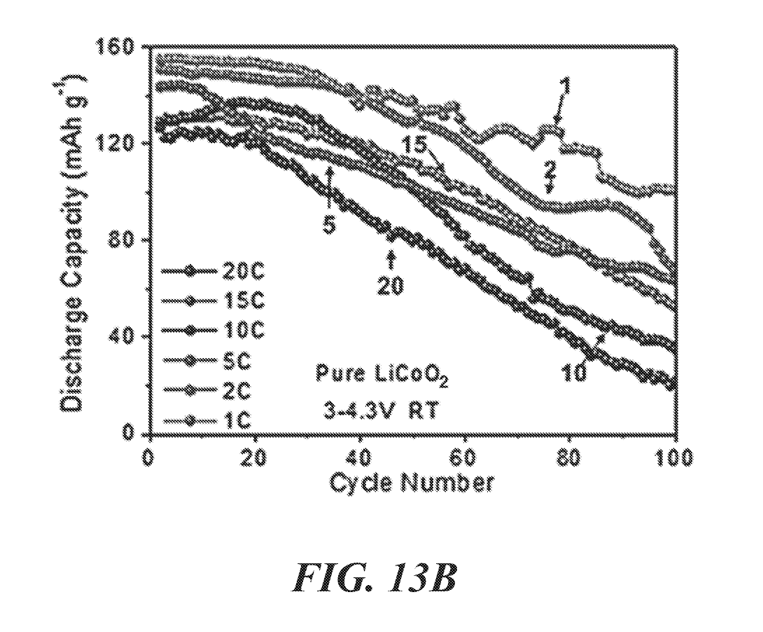

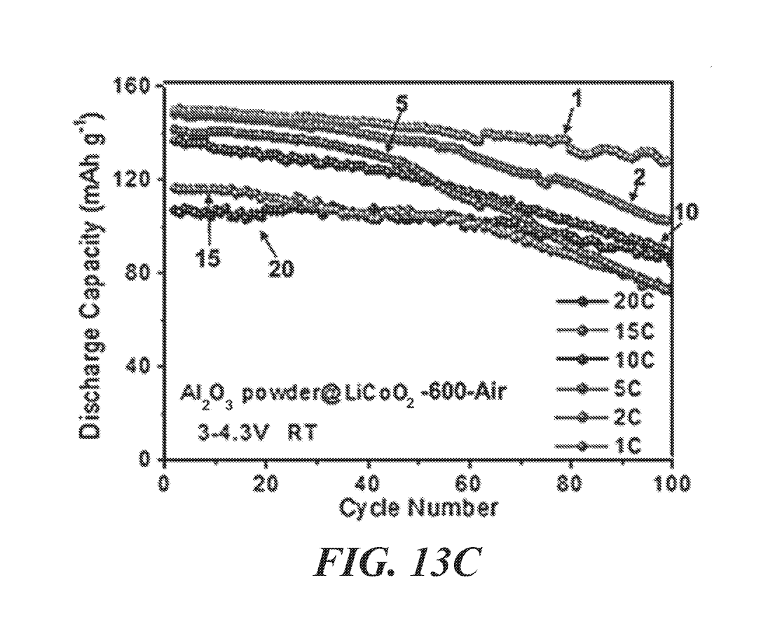

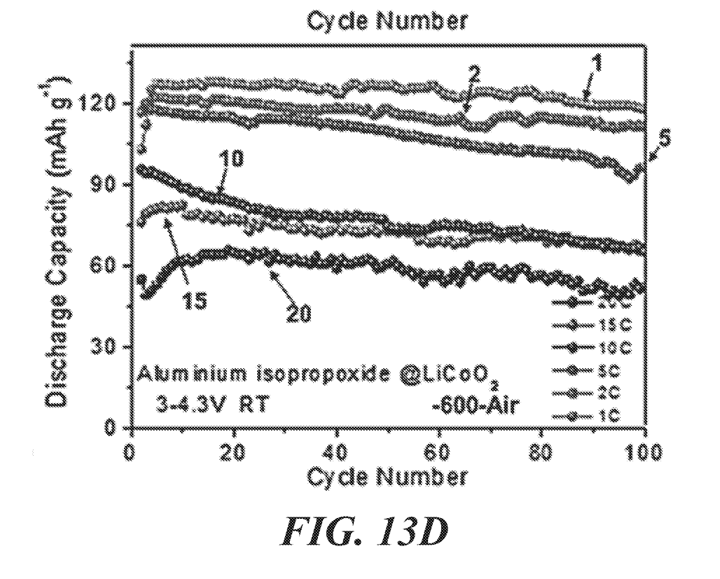

With reference to FIGS. 13A-13D, the cycle-life performances of MIL-53@LiCoO₂-600-Air, pure LiCoO₂, Al₂O₃ powder@ LiCoO₂-600-Air, and aluminum isopropoxide @ LiCoO₂-600-Air, between 3.0 V and 4.3 V at rates of 1C, 2C, 5C, 10C, 15C and 20C were measured. MIL-53@LiCoO₂-600-Air was observed to have the greatest stability at the various rates tested.

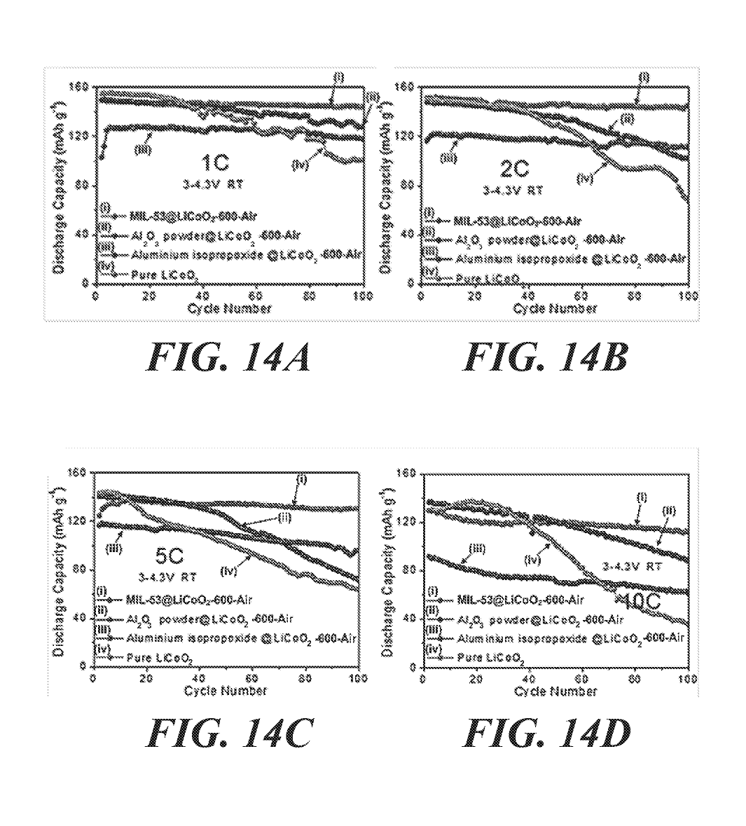

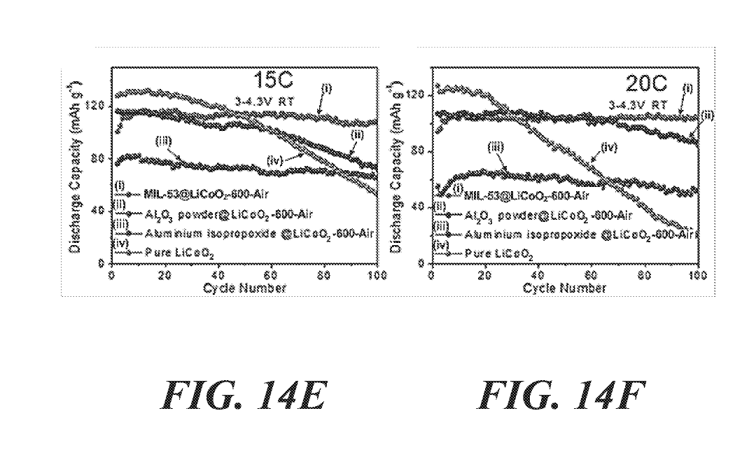

With reference to FIGS. 14A-14F, the cycle-life performance of MIL-53@LiCoO₂-600-Air, Al₂O₃ powder@LiCoO₂-600-Air, aluminum isopropoxide@LiCoO₂-600-Air and pure LiCoO₂ between 3.0 and 4.3V at rates of 1C, 2C, 5C, 10C, 15C and 20C were measured. MIL-53@LiCoO₂-600-Air was once again observed to have the greatest stability at the various rates tested. In particular, FIGS. 14E and 14F demonstrated that MIL-53 @LiCoO₂-600-Air had better stability at higher discharge rates, such as 15C and 20C.

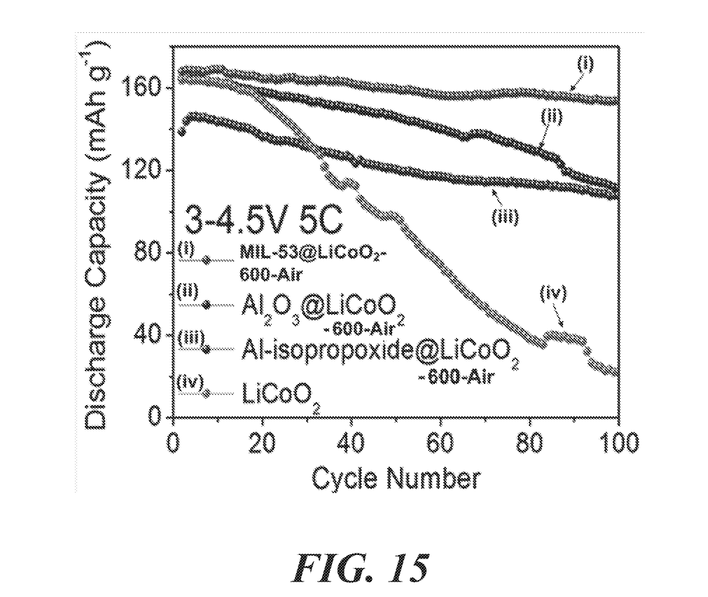

FIG. 15 compares the cycle-life performance of MIL-53@LiCoO₂-600-Air, Al₂O₃ powder@LiCoO₂-600-Air, aluminum isopropoxide@LiCoO₂-600-Air and pure LiCoO₂ between 3.0 and 4.5V at a rate of 5C. MIL-53@LiCoO₂-600-Air was once again observed to have the highest discharge capacity over 100 cycles when compared to the other materials tested.

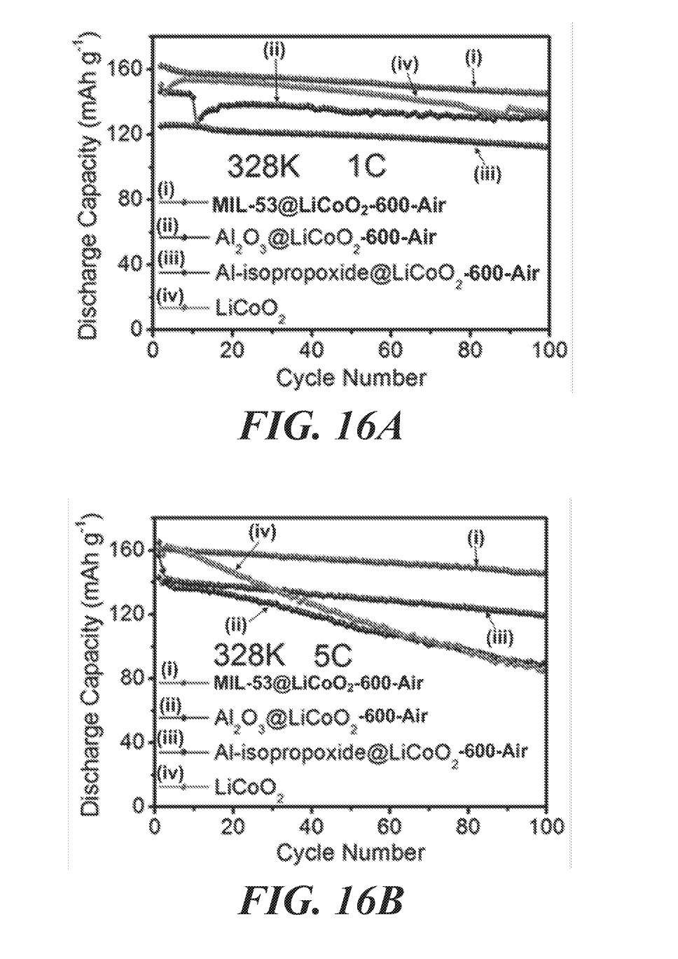

FIGS. 16A and 16B compares the cycle-life performance of MIL-53@LiCoO₂-600-Air, Al₂O₃ powder@LiCoO₂-600-Air, aluminum isopropoxide@ LiCoO₂-600-Air and pure LiCoO₂ between 3.0 and 4.5V at rates of 1C and 5C, respectively, at 55° C. (328 K). The data in these figures show the effect of higher temperature, as the other electrochemical tests in this Example were performed at room temperature (unless otherwise stated). Even at 55° C., MIL-53@LiCoO₂-600-Air was observed to have the highest discharge capacity over 100 cycles when compared to the other materials tested.

### Example 3

### Preparation and Use of LiNi_{0.6}Co_{0.2}Mn_{0.2}O₂ Coated with NH₂-MIL-53

This Example demonstrates the preparation of LiNi_{0.6}Co_{0.2}Mn_{0.2}O₂ (“NCM622”) coated with NH₂-MIL-53, which was then incorporated into cells for use in electrochemical measurements. In this example and the accompanying figures, NCM622 that has not been coated is referred to as “uncoated NCM622” and the NCM622 coated with NH₂-MIL-53 according to the procedure in this example is referred to as “coated NCM622”.

Preparation of NCM622 Coated with NH₂-MIL-53:

NCM622 was used as base material. NH₂-MIL-53, aluminum chloride hexahydrate (AlCl₃.6H₂O, 3.863 g, 16 mmol) and 2-aminobenzene-1,4-dicarboxylate (abdc, 2.898 g, 16 mmol) were mixed with 1000 mg NCM622 powder, followed by ball-milling for 120 mins at 600 rpm using a planetary ball miller. The mixture was then heated at 6000C for 3 h under an air atmosphere to obtain the NCM622 coated with NH₂-MIL-53.

Preparation of NCM Half Cells:

The coin cells (size 2032—20 mm diameter and 3.2 mm high) were assembled in an argon filled glovebox. Lithium foil was used as the anode, and a solution of LiPF₆ (1M) in ethyl carbonate (EC) and diethyl carbonate (DMC) (1:1 vol/vol) was used as the electrolyte. The cathode was made up of a mixture of 80 wt % coated NCM material prepared, 10 wt % Super P and 10 wt % polyvinylidene fluoride (PVDF) dissolved in N-methyl-2-pyrrolidone (NMP). The electrode were then pressed and dried for 12 h at 120° C.

Electrochemical Tests:

Galvanostatic charge/discharge measurements were performed at a constant current of between 0.2 and 10 C (1 C=140 mA g⁻¹) over 3.0-4.5 V using a multichannel battery testing system (LAND CT2001A). All cells were tested at room temperature.

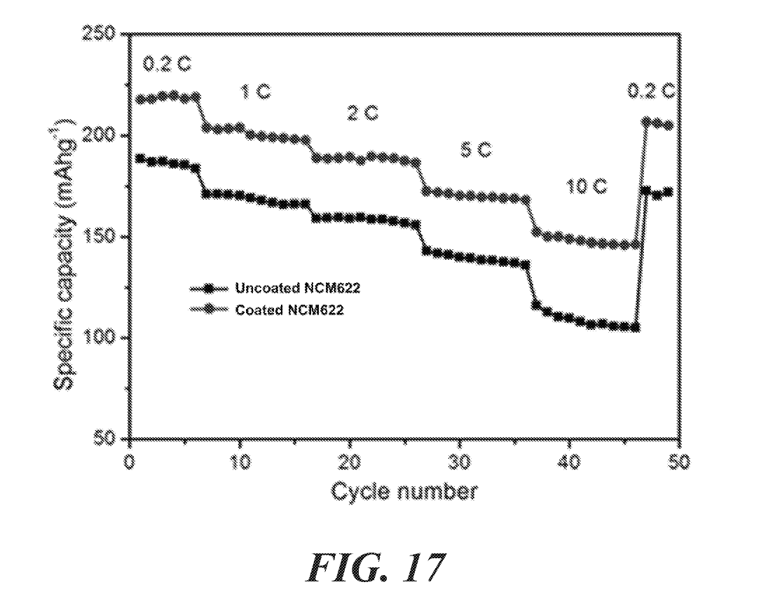

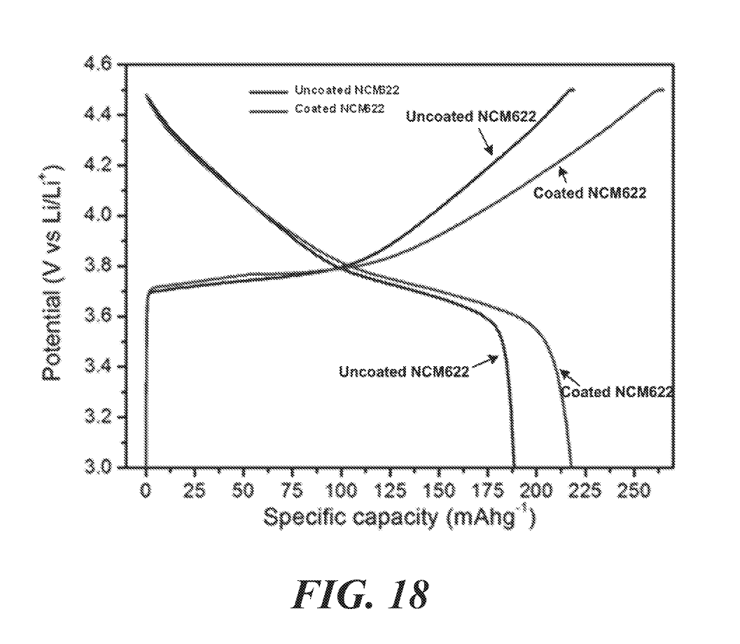

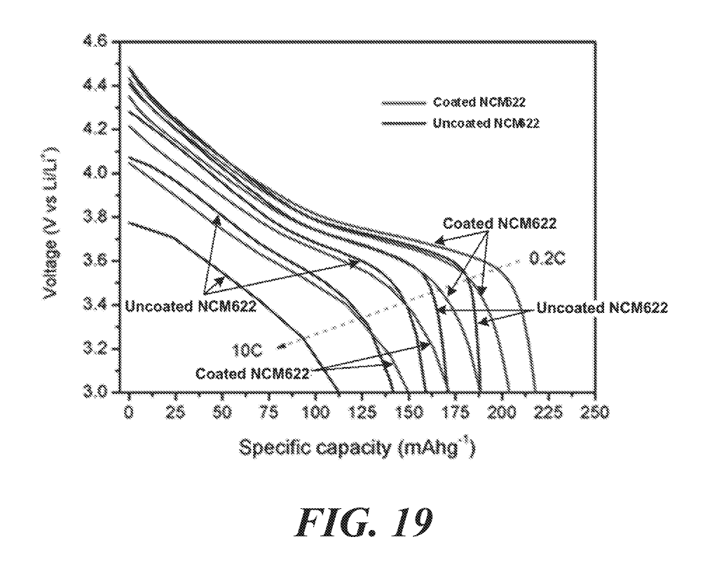

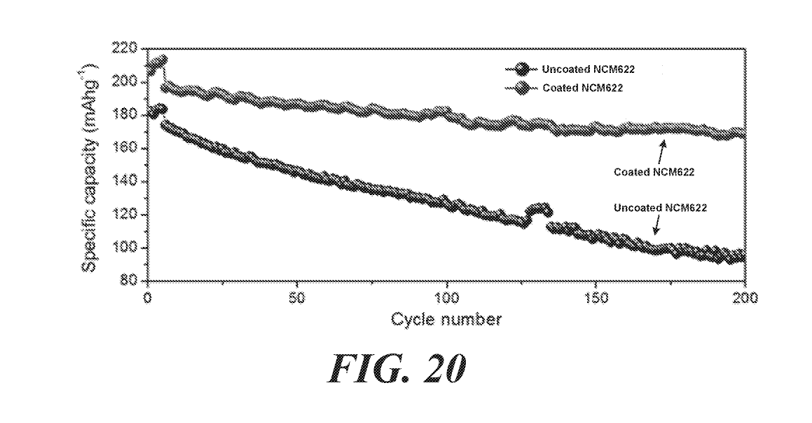

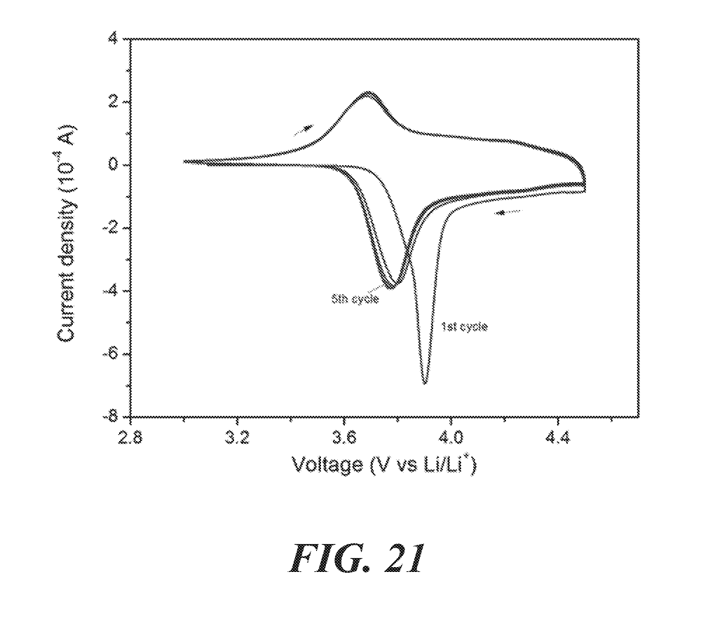

The results from the electrochemical tests are provided in FIGS. 17-21. With reference to FIG. 17, coated NCM622 unexpected showed improved capacities under all charging and discharging rates (0.2C, 1C, 2C, 5C, 10C) as compared to the uncoated NCM622. With reference to FIG. 18, coated NCM shows similar charging and discharging voltage profiles with higher capacity comparing to the non-coated NCM. With reference to FIG. 19, coated NCM shows similar charging and discharging voltage profiles with higher capacity under each charging and discharging rate, as compared to uncoated NCM. With reference to FIG. 20, coated NCM unexpectedly showed better cycle stability comparing to the uncoated NCM. With reference to FIG. 21, the coated NCM was observed to be electrochemically stable.

1. A cathode material for a lithium ion battery, comprising:
lithium metal oxide coated with a metal oxide shell, wherein the metal oxide shell comprises a plurality of metal oxide particles dispersed in a porous carbon matrix,
wherein the cathode material has a discharge capacity over an initial 5 cycles of at least 130 mAh/g at room temperature when discharged from 4.5 V to 3.0 V.

2. The cathode material of claim 1, wherein the plurality of metal oxide particles are uniformly dispersed in the porous carbon matrix.

3. The cathode material of claim 1, wherein the cathode material has a discharge capacity:
(i) over an initial 100 cycles of at least 110 mAh/g at room temperature when discharged from 4.5 V to 3.0 V; or
(ii) over an initial 100 cycles of at least 130 mAh/g at room temperature when discharged from 4.3 V to 3.0 V; or
(iii) over an initial 200 cycles of at least 130 mAh/g at room temperature when discharged from 4.3 V to 3.0 V; or
(iv) over an initial 300 cycles of at least 130 mAh/g at room temperature when discharged from 4.3 V to 3.0 V; or
(v) over an initial 100 cycles of at least 90 mAh/g at room temperature when discharged from 4.3 V to 3.0 V; or
(vi) over an initial 100 cycles of at least 90 mAh/g at room temperature when discharged from 4.3 V to 3.0 V; or
(vii) over an initial 100 cycles of at least 150 mAh/g at room temperature when discharged from 4.5 V to 3.0 V; or
(viii) over an initial 100 cycles of at least 150 mAh/g at 328 K when discharged from 4.3 V to 3.0 V; or
(ix) over an initial 100 cycles of at least at least 150 mAh/g at 328 K when discharged from 4.3 V to 3.0 V; or
any combinations of discharge capacities (i)-(ix).

4. The cathode material of claim 1, wherein the lithium metal oxide coated with a metal oxide shell is obtained by a method comprising:
mechanochemically processing (i) one or more organic linking compounds, (ii) one or more metal compounds; and (iii) lithium metal oxide to produce lithium metal oxide coated with a metal-organic framework shell; and
pyrolyzing the lithium metal oxide coated with the metal-organic framework shell to produce the lithium metal oxide coated with a metal oxide shell.

5. The cathode material of claim 4, wherein the one or more organic linking compounds are independently:
an aryl with at least one phenyl ring substituted with at least one —COOH moiety, or
a heteroaryl with at least pyridyl ring substituted with at least one —COOH moiety.

6. The cathode material of claim 4, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.

7. The cathode material of claim 4, wherein the one or more organic linking compounds are independently:
a monocyclic five-membered heteroaryl having at least two nitrogen atoms, wherein two of the nitrogen atoms are configured in the 1- and 3-positions of the monocyclic five-membered ring, or
a bicyclic ring system made up of at least one five-membered ring having at least two nitrogen atoms, wherein two of the nitrogen atoms are configured in the 1- and 3-positions of the five-membered ring.

8. The cathode material of claim 4, wherein the one or more metal compounds independently comprise scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), or magnesium (Mg) ions, or any combinations thereof

9. The cathode material of claim 4, wherein the metal-organic framework is NH₂-MIL-53, MIL-53, MOF-519, MOF-520, MOF-5, MOF-177, ZIF-8, ZIF-11, MOF-74, or any combinations thereof.

10. The cathode material of claim 4, wherein the metal-organic framework is an aluminum-based metal-organic framework.

11. The cathode material of claim 1, wherein the lithium metal oxide comprises nickel, cobalt, manganese, or iron, or any combinations thereof.

12. The cathode material of claim 1, wherein the lithium metal oxide is LiNiₓCo_{y}Mn_{z}Oₐ, wherein:
x is 0 to 3;
y is 0 to 3;
z is 0 to 3; and
a is 0.1 to 10,
provided that at least one of x, y and z is greater than 0.

13. The cathode material of claim 1, wherein the lithium metal oxide is LiCoO₂, LiMnO₂, LiMnO₃, LiMn₂O₄, LiNiO₂, LiNi_{0.5}Mn_{1.5}O₄, LiNiCoMnO₂, or LiNi_{0.6}Co_{0.2}Mn_{0.2}O₂, or any combinations thereof.

14. The cathode material of claim 1, wherein the metal oxide particles are aluminum oxide particles, zirconium oxide particles, titanium oxide particles, or zinc oxide particles, or any combinations thereof.

15. A lithium ion battery comprising:
a cathode comprising a cathode material of claim 1;
an anode; and
a separator between the cathode and anode.

16. A lithium metal oxide composite, comprising:
lithium metal oxide coated with a metal oxide shell, wherein the metal oxide shell comprises a plurality of metal oxide particles dispersed in a porous carbon matrix.

17. The composite of claim 16, wherein the plurality of metal oxide particles are uniformly dispersed in the porous carbon matrix

18. The composite of claim 16, wherein the metal oxide particles are dispersed in the porous carbon matrix within a distance between about 0.5 nm to 5 nm apart.

19. The composite of claim 16, wherein the lithium metal oxide comprises nickel, cobalt, manganese, or iron, or any combinations thereof.

20. The composite of claim 16, wherein the lithium metal oxide is LiNiₓCo_{y}Mn_{z}Oₐ, wherein:
x is 0 to 3;
y is 0 to 3;
z is 0 to 3; and
a is 0.1 to 10,
provided that at least one of x, y and z is greater than 0.

21. The composite of claim 16, wherein the lithium metal oxide is LiCoO₂, LiMnO₂, LiMnO₃, LiMn₂O₄, LiNiO₂, LiNi_{0.5}Mn_{1.5}O₄, LiNiCoMnO₂, or LiNi_{0.6}Co_{0.2}Mn_{0.2}O₂, or any combinations thereof.

22. The composite of claim 16, wherein the metal oxide particles comprise one or more metals selected from the group consisting of an early transition metal, aluminum or magnesium.

23. The composite of claim 16, wherein the metal oxide particles comprise one or more metals selected from the group consisting of scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), and magnesium (Mg), or any combinations thereof.

24. The composite of claim 16, wherein the metal oxide particles are aluminum oxide particles, zirconium oxide particles, titanium oxide particles, or zinc oxide particles, or any combinations thereof.

25. The composite of claim 16, wherein the porous carbon matrix is obtained by pyrolyzing a metal-organic framework shell coating the lithium metal oxide.

26. The composite of claim 25, wherein the metal-organic framework shell is an aluminum-based metal-organic framework shell, a zinc-based metal-organic framework shell, a zirconium-based metal-organic framework shell, or a magnesium-based metal-organic framework shell.

27. The composite of claim 25, wherein the metal-organic framework shell comprises NH₂-MIL-53, MIL-53, MOF-519, MOF-520, MOF-5, MOF-177, ZIF-8, ZIF-11, MOF-74, or any combinations thereof.

28. A method for producing a lithium metal oxide composite comprising lithium metal oxide coated with a metal oxide shell, the method comprising:
mechanochemically processing a metal-organic framework with lithium metal oxide to produce lithium metal oxide coated with a metal-organic framework shell; and
pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix.

29. The method of claim 28, wherein the method further comprises:
mechanochemically processing (i) one or more organic linking compounds, and (ii) one or more metal compounds to produce the metal-organic framework,
wherein the metal-organic framework comprises an open framework produced from the one or more organic linking compounds and the one or more metal compounds, wherein the open framework has one or more pores.

30. A method for producing a lithium metal oxide composite comprising lithium metal oxide coated with a metal oxide shell, the method comprising:
mechanochemically processing (i) one or more organic linking compounds, (ii) one or more metal compounds; and (iii) lithium metal oxide to produce lithium metal oxide coated with a metal-organic framework shell; and
pyrolyzing the lithium metal oxide coated with the metal-organic framework shell to produce lithium metal oxide coated with a metal oxide shell, wherein the metal oxide shell includes a plurality of metal oxide particles dispersed in a porous carbon matrix.

31. The method of claim 29, wherein the one or more organic linking compounds are independently:
an aryl with at least one phenyl ring substituted with at least one —COOH moiety, or
a heteroaryl with at least pyridyl ring substituted with at least one —COOH moiety.

32. The method of claim 29, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.

33. The method of claim 29, wherein the one or more organic linking compounds are independently:
a monocyclic five-membered heteroaryl having at least two nitrogen atoms, wherein two of the nitrogen atoms are configured in the 1- and 3-positions of the monocyclic five-membered ring, or
a bicyclic ring system made up of at least one five-membered ring having at least two nitrogen atoms, wherein two of the nitrogen atoms are configured in the 1- and 3-positions of the five-membered ring.

34. The method of claim 29, wherein the one or more metal compounds independently comprise scandium (Sc), titanium (Ti), vanadium (V), chromium (Cr), manganese (Mn), iron (Fe), cobalt (Co), nickel (Ni), copper (Cu), zinc (Zn), gallium (Ga), zirconium (Zr), molybdenum (Mo), aluminum (Al), or magnesium (Mg) ions, or any combinations thereof

35. The method of claim 29, wherein the metal-organic framework shell comprises NH₂-MIL-53, MIL-53, MOF-519, MOF-520, MOF-5, MOF-177, ZIF-8, ZIF-11, MOF-74, or any combinations thereof.

36. The method of claim 29, wherein the metal-organic framework is an aluminum-based metal-organic framework.

37. A lithium metal oxide composite produced according to claim 28.

38. An electrode, comprising:
a lithium metal oxide composite according to claim 16; and
binder.

39. The electrode of claim 38, wherein the electrode is a cathode.

40. A battery, comprising:
a cathode of claim 39;
an anode; and
lithium ions.

41. A lithium ion battery comprising:
a cathode comprising the cathode material of claim 1;
an anode; and
a separator between the cathode and anode.
